(19) United States
(12) Patent Application Publication
(10) Pub. No.: US 2026/0217993 A1
(43) Pub. Date: Jul. 30, 2026

(54) ELECTRODEPOSITABLE COATING COMPOSITIONS

(71) Applicant: PPG Industries Ohio, Inc., Cleveland, OH (US)

(72) Inventors: Christophe Rene Gaston Grenier, Pittsburgh, PA (US); Venkateshwarlu Kalsani, JR., Gibsonia, PA (US); David Alfred Stone, Allison Park, PA (US); Hongying Zhou, Allison Park, PA (US); Trevor Brenton Morris, Allison Park, PA (US)

(73) Assignee: PPG Industries Ohio, Inc., Cleveland, OH (US)

(21) Appl. No.: 19/144,990

(22) PCT Filed: Jan. 3, 2024
(86) PCT No.: PCT/US2024/010106

§ 371 Date: Jul. 1, 2025

Related U.S. Application Data
(60) Provisional application No. 63/478,531, filed on Jan. 5, 2023.

(51) Int. Cl. C09D 5/44; C09D 163/10

(52) U.S. Cl. CPC C09D 5/4457; C09D 163/10

(57) ABSTRACT

The present disclosure is directed to an electrodepositable coating composition comprising a cationic salt-group-containing, film-forming resin dispersed in an aqueous medium, the cationic salt-group-containing, film-forming resin comprising the reaction product of a reaction mixture comprising: (a) a polyepoxide; (b) at least one polyol comprising an aliphatically substituted phenol comprising at least two phenolic hydroxyl groups; and (c) a cationic salt group former. The present disclosure is also directed to methods of coating substrates and coated substrates.

### FIELD

The present disclosure is directed towards an electrodepositable coating composition, coatings, coated substrates, and methods of coating substrates.

### BACKGROUND

Electrodeposition as a coating application method involves the deposition of a film-forming composition under the influence of an applied electrical potential onto a conductive substrate immersed in the electrodepositable coating composition. Electrodeposition has gained popularity in the coatings industry because it provides higher paint utilization, outstanding corrosion resistance, and low environmental contamination as compared with non-electrophoretic coating methods. Bisphenol A is commonly used as a component for making resins used in electrodepositable coating compositions, but bisphenol A presents health concerns. An electrodepositable coating composition having a reduced level of bisphenol A is desired.

### BRIEF DESCRIPTION OF THE DRAWINGS

FIG. 1 shows an isometric view of the box used in the “Nagoya Box Method” referenced in the Examples section.

FIG. 2 shows a sectional view of the box used in the “Nagoya Box Method” referenced in the Examples section.

### SUMMARY

The present disclosure provides an electrodepositable coating composition comprising a cationic salt-group-containing, film-forming resin dispersed in an aqueous medium, the cationic salt-group-containing, film-forming resin comprising the reaction product of a reaction mixture comprising: (a) a polyepoxide; (b) at least one polyol comprising an aliphatically substituted phenol comprising at least two phenolic hydroxyl groups; and (c) a cationic salt group former.

The present disclosure also provides a method of coating a substrate comprising electrophoretically applying an electrodepositable coating composition to at least a portion of the substrate, wherein the electrodepositable coating composition comprises a cationic salt-group-containing, film-forming resin dispersed in an aqueous medium, the cationic salt-group-containing, film-forming resin comprising the reaction product of a reaction mixture comprising: (a) a polyepoxide; (b) at least one polyol comprising an aliphatically substituted phenol comprising at least two phenolic hydroxyl groups; and (c) a cationic salt group former.

The present disclosure further provides a coated substrate comprising a cured coating film comprising the reaction product of (1) a cationic salt-group-containing, film-forming resin dispersed in an aqueous medium, the cationic salt-group-containing, film-forming resin comprising the reaction product of a reaction mixture comprising (a) a polyepoxide; (b) at least one polyol comprising an aliphatically substituted phenol comprising at least two phenolic hydroxyl groups; and (c) a cationic salt group former; and (2) a curing agent.

### DETAILED DESCRIPTION

The present disclosure is directed to an electrodepositable coating composition comprising a cationic salt-group-containing, film-forming resin dispersed in an aqueous medium, the cationic film-forming resin comprising the reaction product of a reaction mixture comprising (a) a polyepoxide; (b) at least one polyol comprising an aliphatically substituted phenol comprising at least two phenolic hydroxyl groups; and (c) a cationic salt group former.

As used herein, the term “electrodepositable coating composition” refers to a composition that is capable of being deposited onto an electrically conductive substrate under the influence of an electrical potential applied between two electrodes immersed in the electrodepositable coating composition, where one of the electrodes is the substrate to be coated.

As used herein, the term “cationic salt group-containing film-forming polymer” refers to polymers that include at least partially neutralized cationic groups, such as sulfonium groups and ammonium groups, that impart a positive charge. As used herein, the term “polymer” encompasses, but is not limited to, oligomers and both homopolymers and copolymers.

As used herein, the term “polyepoxide” refers to a compound or polymer having at least two epoxide functional groups, such as at least three, such as at least four, or more.

As used herein, the term “polyol” refers to a compound or polymer having at least two hydroxyl functional groups, such as at least three, such as at least four, or more.

As used herein, the term “aliphatically substituted phenol” refers to a compound comprising at least one phenol comprising at least one alkyl substituent covalently bonded to the benzene ring of the phenol (i.e., phenyl group) that also includes at least one hydroxyl functional group(s) (i.e., phenolic hydroxyl group). The at least one alkyl substituent may optionally include another phenolic hydroxyl functional group through substitution of the alkyl substituent with one or more substituted or unsubstituted phenyl groups so long as the alkyl substituent is not [—C(R)₂Ph], wherein each R is independently CH₃ or H, if there are no other alkyl substituents present on any of the phenyl groups of the aliphatically substituted phenol. The aliphatically substituted phenol may optionally further comprise other substituents.

As used herein, the term “phenolic hydroxyl” refers to a hydroxyl group present as a substituent covalently bonded to a benzene ring (i.e., a phenyl group).

As used herein, the term “alkyl” refers to a hydrocarbon chain substituent equivalent to an alkane missing one hydrogen and may be saturated or unsaturated. The alkyl substituent may be linear or branched and may comprise one or more hydrocarbon rings that are not aromatic.

As used herein, the term “unsaturated aliphatic group” refers to an alkyl group having at least one degree of unsaturation (i.e., at least one unsaturated group, [—C(R)═C(R)—], wherein each R is independently an alkyl group or H).

As used herein, the term “phenolic lipid” refers to a benzene ring having at least one phenolic hydroxyl functional group and at least one aliphatic substituent comprising at least three carbon atoms covalently bonded to the benzene ring.

The polyepoxide may comprise any compound or mixture of compounds having 2 epoxide groups per molecule.

The polyepoxide may comprise an aromatic polyepoxide, an aliphatic polyepoxide, or any combination thereof.

As used herein, an “aromatic polyepoxide” refers to a polyepoxide having at least one aryl group. As used herein, “aryl” refers to a hydrocarbon having a delocalized conjugated π-system with alternating double and single covalent bonds between carbon atoms forming one or more coplanar hydrocarbon rings.

Non-limiting examples of an aromatic polyepoxide include a polyglycidyl ether of an aromatic polyphenol, such as a diglycidyl ether of bisphenol A, bisphenol S, bisphenol F, or biphenol. As will be appreciated, such polyepoxides can be produced by etherification of an aromatic polyphenol with an epichlorohydrin in the presence of an alkali. Suitable polyphenols that may be used to produce the polyepoxide include, without limitation, dihydroxy benzene, 1,1-bis(4-hydroxyphenyl)ethane; 2,2-bis(4-hydroxyphenyl)propane; 1,1-bis(4-hydroxyphenyl)isobutane; 2,2-bis(4-hydroxytertiarybutylphenyl)propane; bis(2-hydroxynaphthyl)methane; 1,5-dihydroxynaphthalene; 1,1-bis(4-hydroxy-3-allylphenyl)ethane; and 4,4-bis(4′-hydroxyphenyl)valeric acid. Another useful class of polyepoxides may be produced similarly from polyphenol resins that include an aryl group. In addition, addition polymerization polymers containing pendant epoxy groups made by copolymerizing a variety of polymerizable ethylenically unsaturated monomers at least one of which is an epoxy containing monomer and at least one co-monomer having an aryl group, such as, for example, monovinyl aromatic monomers such as styrene and vinyl toluene.

The aromatic polyepoxides may include those that do not include any residue of bisphenol A, bisphenol S, and/or bisphenol F such that the aromatic polyepoxide and the resulting reaction product is free of the residue of bisphenol A, bisphenol S, and/or bisphenol F. Non-limiting examples of the aromatic polyepoxide include a novolac resin, di- or polyglycidyl ethers of any of the aliphatically substituted phenols described below, and diglycidyl ethers of a dihydroxy benzene such as catechol, resorcinol, or hydroquinone. For example, the aromatic polyepoxide may comprise a compound having the structure:

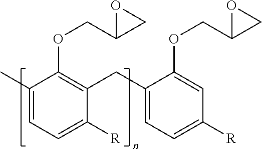

wherein each R independently comprises hydrogen, an unsubstituted or substituted, branched or linear, saturated or unsaturated, cyclic, acyclic, or part cyclic aliphatic, aromatic, or aryl-aliphatic group, and n is an integer from 1 to 3. Another non-limiting example of the aromatic polyepoxide is a compound having the structure:

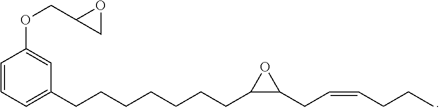 [SMILES: CCC/C=C\CC1OC1CCCCCCCc1cccc(OCC2CO2)c1]

Another non-limiting example of the aromatic polyepoxide is a compound having the structure:

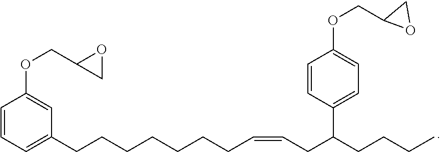 [SMILES: CCCCC(C/C=C\CCCCCCCc1cccc(OCC2CO2)c1)c1ccc(OCC2CO2)cc1]

Another non-limiting example of the aromatic polyepoxide is a compound having the structure:

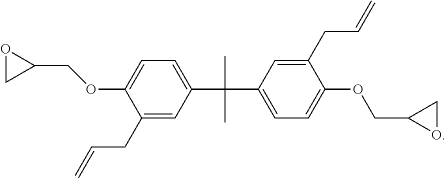 [SMILES: C=CCc1cc(C(C)(C)c2ccc(OCC3CO3)c(CC=C)c2)ccc1OCC1CO1]

Another non-limiting example of the aromatic polyepoxide is a compound having the structure:

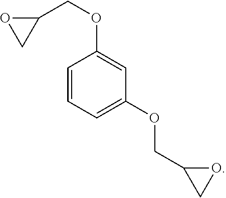 [SMILES: c1cc(OCC2CO2)cc(OCC2CO2)c1]

As used herein, an “aliphatic polyepoxide” refers to a polyepoxide that does not include an aryl group.

Non-limiting examples of aliphatic polyepoxides include addition polymerization polymers containing pendant epoxy groups. Such polymers may be made by copolymerizing a variety of polymerizable ethylenically unsaturated monomers at least one of which is an epoxy containing monomer, e.g., glycidyl acrylate or glycidyl methacrylate. Any suitable ethylenically unsaturated monomer that does not contain a group that is reactive with the epoxy group may be employed as a comonomer. Exemplary such monomers include α,β-ethylenically unsaturated monomers, such as unsaturated carboxylic acid esters of saturated alcohols containing from 1 to 8 carbon atoms.

Other non-limiting examples of the aliphatic polyepoxide include a polyglycidyl ether of a hydrogenated polyphenol. As will be appreciated, such polyepoxides can be produced by etherification of a hydrogenated polyphenol with an epichlorohydrin in the presence of an alkali. Non-limiting examples include hydrogenated diglycidyl ether of bisphenol A, bisphenol S, or bisphenol F, a diglycidyl ether of a diol, such as, for example, a diglycidyl ether of 1,4-butyldiol, 1,5-pentyldiol, 1,6-hexyldiol, 1,7-heptyldiol, 1,8-octyldiol, and the like, as well as combinations thereof.

The polyepoxide may have a number averaged molecular weight (Mₙ) of at least 100 g/mol, such as at least 150 g/mol. The polyepoxide may have a number averaged molecular weight (Mₙ) of no more than 10,000 g/mol, such as no more than 5,000 g/mol, such as no more than 1,000 g/mol. The polyepoxide may have a number averaged molecular weight (Mₙ) of 100 to 10,000 g/mol, such as 100 to 5,000 g/mol, such as 100 to 1,000 g/mol, such as 150 to 10,000 g/mol, such as 150 to 5,000 g/mol, such as 150 to 1,000 g/mol.

As used herein, unless otherwise stated, the term “number average molecular weight (Mₙ)” means the number average molecular weight (Mₙ) as determined by Gel Permeation Chromatography using a Waters 2695 separation module with a Waters 410 differential refractometer (RI detector), polystyrene standards having molecular weights of from approximately 500 g/mol to 900,000 g/mol, dimethylformamide (DMF) with 0.05 M lithium bromide (LiBr) as the eluent at a flow rate of 0.5 mL/min, and one Asahipak GF-510 HQ column for separation.

The polyepoxide may have an epoxide equivalent weight of at least 50 g/equivalent, such as at least 100 g/equivalent, such as at least 170 g/equivalent. The polyepoxide may have an epoxide equivalent weight of no more than 3,000 g/equivalent, such as no more than 1,500 g/equivalent, such as no more than 1,000 g/equivalent, such as no more than 500 g/equivalent, such as no more than 360 g/equivalent, such as no more than 200 g/equivalent. The polyepoxide may have an epoxide equivalent weight of 50 to 3,000 g/equivalent, such as 50 to 1,500 g/equivalent, such as 50 to 1,000 g/equivalent, such as 50 to 500 g/equivalent, such as 50 to 360 g/equivalent, such as 50 to 200 g/equivalent, such as 100 to 3,000 g/equivalent, such as 100 to 1,500 g/equivalent, such as 100 to 1,000 g/equivalent, such as 100 to 500 g/equivalent, such as 100 to 360 g/equivalent, such as 100 to 200 g/equivalent, such as 170 to 3,000 g/equivalent, such as 170 to 1,500 g/equivalent, such as 170 to 1,000 g/equivalent, such as 170 to 500 g/equivalent, such as 170 to 360 g/equivalent, such as 170 to 200 g/equivalent. As used herein, the “epoxide equivalent weight” is determined by dividing the theoretical molecular weight of the polyepoxide by the number of epoxide groups present in the epoxy-containing compound. In the case of oligomeric or polymeric epoxy compounds, the epoxide equivalent weight is determined by dividing the average molecular weight of the epoxy compound by the average number of epoxide groups present in the molecules. Epoxy equivalent weight can also be determined by titration of a sample using a Metrohm 808 or 888 Titrando, wherein the mass of the polyepoxide used is 0.06 g per 100 g/eq of predicted epoxy equivalent weight. The sample is dissolved in 20 mL of methylene chloride (additional solvent can be used to ensure complete solvation; methanol or tetrahydrofuran may be used as co-solvents) then 40 mL glacial acetic acid is added. One gram of tetraethylammonium bromide is added to the solution before titration with 0.1 N perchloric acid.

The polyepoxide may comprise at least 5% by weight, such as at least 20% by weight, such as at least 25% by weight, such as at least 40% by weight, such as at least 50% by weight, such as at least 60% by weight, such as at least 70% by weight, such as at least 80% by weight, based on the total solids weight of the reaction mixture. The polyepoxide may comprise no more than 95% by weight, such as no more than 75% by weight, such as no more than 60% by weight, such as no more than 50% by weight, such as no more than 40% by weight, based on the total solids weight of the reaction mixture. The polyepoxide may comprise 5% to 95% by weight, such as 5% to 75% by weight, such as 5% to 60% by weight, such as 5% to 50% by weight, such as 5% to 40% by weight, such as 20% to 95% by weight, such as 20% to 75% by weight, such as 20% to 60% by weight, such as 20% to 50% by weight, such as 20% to 40% by weight, such as 25% to 95% by weight, such as 25% to 75% by weight, such as 25% to 60% by weight, such as 25% to 50% by weight, such as 25% to 40% by weight, such as 40% to 95% by weight, such as 40% to 75% by weight, such as 40% to 60% by weight, such as 40% to 50% by weight, such as 50% to 95% by weight, such as 50% to 75% by weight, such as 50% to 60% by weight, such as 60% to 95% by weight, such as 60% to 75% by weight, such as 70% to 95% by weight, such as 70% to 75% by weight, such as 80% to 95% by weight, based on the total solids weight of the reaction mixture. The cationic salt-group-containing, film-forming resin reaction product may comprise the residue of the polyepoxide in the same amounts as it is present in the reaction mixture.

The alkylated phenol may comprise any suitable compound. For example, the aliphatically substituted phenol may comprise a compound having the structure (I):

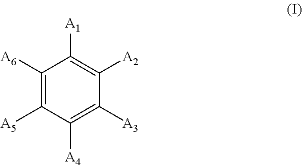

wherein A₁ through A₆ each independently comprise a hydroxyl group, hydrogen, an unsubstituted or substituted, branched or linear, saturated or unsaturated, cyclic, acyclic, or part cyclic aliphatic, aromatic, or aryl-aliphatic group, wherein at least two of A₁ through A₆ is a hydroxyl group, and at least one of A₁ through A₆ is an unsubstituted or substituted, branched or linear, saturated or unsaturated, cyclic, acyclic, or part cyclic aliphatic, aromatic, or aryl-aliphatic group. In a non-limiting example, at least one of A₁ through A₆ may comprise an alkyl group having at least three carbon atoms. A non-limiting example of an aliphatically substituted phenol having the structure (I) is cardol.

The aliphatically substituted phenol may comprise a compound having the structure (II):

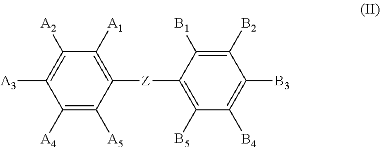

wherein A₁ through A₅ each independently comprise a hydroxyl group, hydrogen, an unsubstituted or substituted, branched or linear, saturated or unsaturated, cyclic, acyclic, or part cyclic aliphatic, aromatic, or aryl-aliphatic group, and at least one of A₁ through A₅ is a hydroxyl group; B₁ through B₅ each independently comprise a hydroxyl group, hydrogen, unsubstituted or substituted, branched or linear, saturated or unsaturated, cyclic, acyclic, or part cyclic aliphatic, aromatic, or aryl-aliphatic, and at least one of B₁ through B₅ is a hydroxyl group; and Z comprises a divalent organic linking group and is not [—C(R)₂—], wherein each R is independently CH₃ or H, if four of A₁ through A₅ and four of B₁ through B₅ are hydrogen. For example, one of A₁ through A₅ comprises an unsaturated aliphatic group and one of B₁ through B₅ comprises an unsaturated aliphatic group. For example, wherein one of A₁ through A₅ comprises an unsaturated aliphatic group comprising 3 or more carbon atoms and having a terminal ethylenically unsaturated group and one of B₁ through B₅ comprises an unsaturated aliphatic group comprising 3 or more carbon atoms and having a terminal ethylenically unsaturated group. The divalent organic linking group of Z comprises an unsubstituted or substituted, branched or linear, saturated or unsaturated, cyclic, acyclic, or part cyclic aliphatic, aromatic, or aryl-aliphatic divalent group having 1-50 carbon atoms, such as 1-30 carbon atoms, such as 1 to 20 carbon atoms, such as 1 to 15 carbon atoms.

A non-limiting example of the aliphatically substituted phenol comprising the compound having the structure (II) may comprise a reaction product of (1) a phenolic lipid comprising an unsaturated aliphatic group and (2) phenol.

The aliphatically substituted phenol may comprise a cardanol-derivative. As used herein, “cardanol” refers to a meta-substituted phenol ring with mono-, di-, or tri-unsaturated carbon chain, such as a 5 to 25-carbon chain, such as a 10 to 20-carbon chain, such as a 15-carbon chain, and a “cardanol derivative” is a compound derived from cardanol. A non-limiting example of the cardanol-derivative for the aliphatically substituted phenol is a compound having the structure (III):

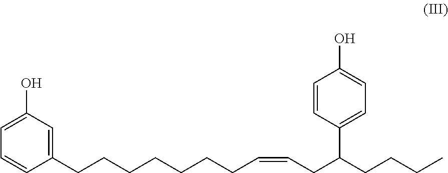 [SMILES: CCCCC(C/C=C\CCCCCCCc1cccc(O)c1)c1ccc(O)cc1]

For example, the compound of structure (III) may comprise the reaction product of cardanol and phenol. Another non-limiting example of a cardanol-derivative for the aliphatically substituted phenol is a compound having the structure (IV):

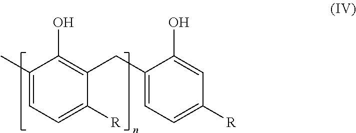

wherein each R independently comprises hydrogen, an unsubstituted or substituted, branched or linear, saturated or unsaturated, cyclic, acyclic, or part cyclic aliphatic, aromatic, or aryl-aliphatic group, and n is an integer from 1 to 3.

The aliphatically substituted phenol may also comprise diallyl bisphenol A. The diallyl bisphenol A has the structure (V):

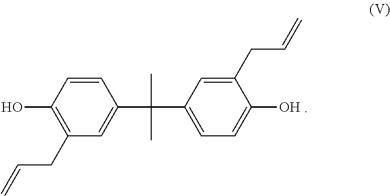 [SMILES: C=CCc1cc(C(C)(C)c2ccc(O)c(CC=C)c2)ccc1O]

A non-limited class of aliphatically substituted phenol includes phenolic lipids.

The aliphatically substituted phenol may have a theoretical hydroxyl value of at least 50 mg KOH/gram aliphatically substituted phenol, such as at least 100 mg KOH/gram, such as at least 150 mg KOH/gram. The aliphatically substituted phenol may have a theoretical hydroxyl value of no more than 2,000 mg KOH/gram aliphatically substituted phenol, such as no more than 700 mg KOH/gram. The aliphatically substituted phenol may have a theoretical hydroxyl value of 50 to 2,000 mg KOH/gram aliphatically substituted phenol, such as 50 to 700 mg KOH/gram, such as 100 to 2,000 mg KOH/gram, such as 100 to 700 mg KOH/gram, such as 150 to 2,000 mg KOH/gram, such as 150 to 700 mg KOH/gram. As used herein, the term “theoretical hydroxyl value” typically refers to the number of milligrams of potassium hydroxide required to neutralize the acetic acid taken up on acetylation of one gram of a chemical substance that contains free hydroxyl groups and was herein determined by a theoretical calculation of the number of free hydroxyl groups theoretically present in one gram of the aliphatically substituted phenol.

The aliphatically substituted phenol may have a number average molecular weight (Mₙ) of at least 110 g/mol, such as at least 150 g/mol. The aliphatically substituted phenol may have a number averaged molecular weight (Mₙ) of no more than 10,000 g/mol, such as no more than 5,000 g/mol, such as no more than 1,000 g/mol. The aliphatically substituted phenol may have a number averaged molecular weight (Mₙ) of 110 to 10,000 g/mol, such as 110 to 5,000 g/mol, such as 110 to 1,000 g/mol, such as 150 to 10,000 g/mol, such as 150 to 5,000 g/mol, such as 150 to 1,000 g/mol.

The aliphatically substituted phenol may comprise at least 5% by weight, such as at least 20% by weight, such as at least 25% by weight, such as at least 40% by weight, such as at least 50% by weight, such as at least 60% by weight, such as at least 70% by weight, such as at least 80% by weight, based on the total solids weight of the reaction mixture. The aliphatically substituted phenol may comprise no more than 95% by weight, such as no more than 75% by weight, such as no more than 60% by weight, such as no more than 50% by weight, such as no more than 40% by weight, based on the total solids weight of the reaction mixture. The aliphatically substituted phenol may comprise 5% to 95% by weight, such as 5% to 75% by weight, such as 5% to 60% by weight, such as 5% to 50% by weight, such as 5% to 40% by weight, such as 20% to 95% by weight, such as 20% to 75% by weight, such as 20% to 60% by weight, such as 20% to 50% by weight, such as 20% to 40% by weight, such as 25% to 95% by weight, such as 25% to 75% by weight, such as 25% to 60% by weight, such as 25% to 50% by weight, such as 25% to 40% by weight, such as 40% to 95% by weight, such as 40% to 75% by weight, such as 40% to 60% by weight, such as 40% to 50% by weight, such as 50% to 95% by weight, such as 50% to 75% by weight, such as 50% to 60% by weight, such as 60% to 95% by weight, such as 60% to 75% by weight, such as 70% to 95% by weight, such as 70% to 75% by weight, such as 80% to 95% by weight, based on the total solids weight of the reaction mixture. The cationic salt-group-containing, film-forming resin reaction product may comprise the residue of the aliphatically substituted phenol in the same amounts as it is present in the reaction mixture.

The ratio of epoxide functional groups from the polyepoxide to hydroxyl functional groups from the polyol may be from 2:0.1 to 2:1.9, such as 10:1 to 1.1:1, such as 5:1 to 1.1:1, such as 3:1 to 1.1:1, such as 2.5:1 to 1.1:1, such as 2.1:1 to 1.9:1, such as 2:1.

As used herein, the term “cationic salt group former” refers to a material which is reactive with epoxy groups and which may be acidified before, during, or after reaction with the epoxy groups to form cationic salt groups. Specifically, the cationic salt group former may react with the epoxy groups of the polyepoxide in order to allow for the incorporation of cationic salt groups in the cationic salt-group-containing, film-forming resin. The cationic salt groups may be incorporated into the cationic salt group-containing film-forming resin as follows: The film-forming polymer may be reacted with a cationic salt group former. Examples of suitable materials include amines such as primary or secondary amines which can be acidified after reaction with the epoxy groups to form amine salt groups, or tertiary amines which can be acidified prior to reaction with the epoxy groups and which after reaction with the epoxy groups form quaternary ammonium salt groups. Sulfonium groups may also be formed by reaction of a secondary thiol with epoxy.

The reaction product may be formed by any suitable method.

For example, the polyepoxide, (b) the aliphatically substituted phenol, and (c) the cationic salt group former may react to form the reaction product in a single step.

Alternatively, the reaction product may be formed by reacting (a) the polyepoxide and (b) the aliphatically substituted phenol in a first step to form an intermediate product, followed by reacting the intermediate product and (c) the cationic salt group former in a second step.

The reaction mixture may optionally further comprise other di- or poly-functional chain extenders. For example, the di- or poly-functional chain extender may comprise a di- or poly-hydroxyl functional reactant, a di- or poly-carboxylic acid functional reactant, or a di- or poly-primary amine functional reactant. The reaction product may also comprise these optional components.

The di-carboxylic acid functional reactant may comprise, for example, dimer fatty acids, such as dimer fatty acids of oleic and/or linoleic acid, alkyl diacids, and combinations thereof.

As mentioned above, the reaction mixture may optionally further comprise di-hydroxyl-functional reactants including, for example, bisphenol A, bisphenol F, bisphenol S, bi-phenol, a dihydroxy benzene such as catechol, resorcinol, or hydroquinone, or a combination thereof. The reaction product may also comprise these optional components.

The reaction mixture may optionally further comprise bisphenol A, bisphenol F, bisphenol S, bi-phenol, a dihydroxy benzene such as catechol, resorcinol, or hydroquinone, or a combination thereof in an amount of 0% to 65% by weight, such as 0% to 40% by weight, such as 0% to 30% by weight, such as 0% to 25% by weight, such as 0% to 20% by weight, such as 0% to 15% by weight, such as 0% to 10% by weight, such as 0% to 5% by weight, the % by weight based on the total solids weight of the reaction mixture. The cationic salt-group-containing, film-forming resin reaction product may comprise the residue of any of these components in the same amounts as it is present in the reaction mixture.

The reaction mixture may comprise bisphenol A in an amount of less than 65% by weight, such as less than 40% by weight, such as less than 30% by weight, such as less than 25% by weight, such as less than 20% by weight, such as less than 15% by weight, such as less than 10% by weight, such as less than 5% by weight, such as less than 3% by weight, such as less than 1% by weight, or less, the % by weight based on the total solids weight of the reaction mixture. The cationic salt-group-containing, film-forming resin reaction product may comprise the residue of bisphenol A in the same amounts as it is present in the reaction mixture.

The reaction mixture and resulting reaction product may be substantially free, essentially free, or completely free of bisphenol A. As used herein, the term “substantially free” means that bisphenol A is present, if at all, in an amount of less than 0.1% by weight, based on the resin solids of the reaction mixture or the total weight of the reaction product. As used herein, the term “essentially free” means that bisphenol A is present, if at all, in an amount of less than 0.01% by weight, based on the resin solids of the reaction mixture or the total weight of the reaction product. As used herein, the term “completely free” means that bisphenol A is not present, i.e., 0.000% by weight, based on the resin solids of the reaction mixture or the total weight of the reaction product.

The reaction mixture and resulting reaction product may be substantially free, essentially free, or completely free of bisphenol F. As used herein, the term “substantially free” means that bisphenol F is present, if at all, in an amount of less than 0.1% by weight, based on the resin solids of the reaction mixture or the total weight of the reaction product. As used herein, the term “essentially free” means that bisphenol F is present, if at all, in an amount of less than 0.01% by weight, based on the resin solids of the reaction mixture or the total weight of the reaction product. As used herein, the term “completely free” means that bisphenol F is not present, i.e., 0.000% by weight, based on the resin solids of the reaction mixture or the total weight of the reaction product.

The reaction mixture and resulting reaction product may be substantially free, essentially free, or completely free of bisphenol S. As used herein, the term “substantially free” means that bisphenol S is present, if at all, in an amount of less than 0.1% by weight, based on the resin solids of the reaction mixture or the total weight of the reaction product. As used herein, the term “essentially free” means that bisphenol S is present, if at all, in an amount of less than 0.01% by weight, based on the resin solids of the reaction mixture or the total weight of the reaction product. As used herein, the term “completely free” means that bisphenol S is not present, i.e., 0.000% by weight, based on the resin solids of the reaction mixture or the total weight of the reaction product.

The reaction mixture may optionally further comprise a lipid phenol. As used herein, lipidic phenol refers to a phenol having at least one saturated or unsaturated, substituted or unsubstituted hydrocarbon substituent comprising at least 3 carbon atoms, such as at least 5 carbon atoms, such as at least 6 carbon atoms, such as at least 8 carbon atoms, such as at least 12 carbon atoms. The lipid phenol may optionally further comprise one or more additional phenolic hydroxyl groups and may optionally comprise other functional groups, such as, for example, carboxylic acid groups. The reaction product may also comprise the residue of lipidic phenols.

The reaction mixture may optionally further comprise a mono-functional active-hydrogen-containing component, a mono-functional epoxide-containing component, a mono-functional acid-containing component, or a combination thereof. The reaction product may also comprise these optional components.

The reaction mixture may optionally further comprise a poly-functional group-containing component comprising two or more functional groups, wherein the functional groups comprise carboxylic acid-functional groups, acid anhydrides, hydroxyl functional groups, a primary amino-functional group, a secondary amino-functional group, thiols, polysulfides, or any combination thereof. The reaction product may also comprise these optional components.

The reaction mixture may optionally further comprise a mono-functional group-containing component comprising a primary amino-functional group-containing component, a mono-functional thiol group-containing component, a mono-functional carboxylic acid group-containing component, a mono-functional epoxide group-containing component, a mono-functional hydroxyl group-containing component (for example, phenol), other mono-functional active hydrogen group-containing component, a mono-functional isocyanato group-containing component, among other mono-functional group-containing components. The reaction product may also comprise these optional components.

The cationic salt-group-containing, film-forming resin may have a number average molecular weight of at least 400 g/mol, such as at least 1,000 g/mol, such as at least 2,000 g/mol. The cationic salt-group-containing, film-forming resin may have a number average molecular weight of no more than 50,000 g/mol, such as no more than 20,000 g/mol, such as no more than 5,000 g/mol, such as no more than 3,000 g/mol. The cationic salt-group-containing, film-forming resin may have a number average molecular weight of 400 to 50,000 g/mol, such as 400 to 20,000 g/mol, such as 400 to 5,000 g/mol, such as 400 to 3,000 g/mol, such as 1,000 to 50,000 g/mol, such as 1,000 to 20,000 g/mol, such as 1,000 to 5,000 g/mol, such as 1,000 to 3,000 g/mol, such as 2,000 to 50,000 g/mol, such as 2,000 to 20,000 g/mol, such as 2,000 to 5,000 g/mol, such as 2,000 to 3,000 g/mol, as measured by gel permeation chromatography using polystyrene standards.

The cationic salt-group-containing, film-forming resin may have a weight average molecular weight of 400 g/mol, such as at least 1,000 g/mol, such as at least 2,000 g/mol. The cationic salt-group-containing, film-forming resin may have a weight average molecular weight of no more than 200,000 g/mol, such as no more than 50,000 g/mol, such as no more than 20,000 g/mol, such as no more than 5,000 g/mol, such as no more than 3,000 g/mol. The cationic salt-group-containing, film-forming resin may have a weight average molecular weight of 400 to 200,000 g/mol, such as 400 to 50,000 g/mol, such as 400 to 20,000 g/mol, such as 400 to 5,000 g/mol, such as 400 to 3,000 g/mol, such as 1,000 to 200,000 g/mol, such as 1,000 to 50,000 g/mol, such as 1,000 to 20,000 g/mol, such as 1,000 to 5,000 g/mol, such as 1,000 to 3,000 g/mol, such as 2,000 to 200,000 g/mol, such as 2,000 to 50,000 g/mol, such as 2,000 to 20,000 g/mol, such as 2,000 to 5,000 g/mol, such as 2,000 to 3,000 g/mol, as measured by gel permeation chromatography using polystyrene standards.

The cationic salt-group-containing, film-forming resin may be a main vehicle resin. As used herein, a “main vehicle resin” refers to a resinous component that comprises more than 50% by weight of the resin solids of the electrodepositable coating composition, not counting the curing agent. The main vehicle resin is the main film-forming polymer that reacts with the curing agent during cure of the electrodepositable coating composition. A main vehicle resin may be present in an amount of greater than 50% by weight of the resin solids of the electrodepositable coating composition, not counting the curing agent, such as at least 60% by weight, such as at least 70% by weight, such as at least 80% by weight, such as at least 90% by weight, such as at least 95% by weight.

If present as a main vehicle resin, the cationic salt-group-containing, film-forming resin may be present in an amount of at least 40% by weight, such as at least 50% by weight, such as at least 60% by weight, based on the total weight of the resin solids of the electrodepositable coating composition. If present as a main vehicle resin, the cationic salt-group-containing, film-forming resin may be present in an amount of no more than 90% by weight, such as no more than 80% by weight, such as no more than 75% by weight, based on the total weight of the resin solids of the electrodepositable coating composition. If present as a main vehicle resin, the cationic salt-group-containing, film-forming resin may be present in an amount of 40% to 90% by weight, such as 40% to 80% by weight, such as 40% to 75% by weight, such as 50% to 90% by weight, such as 50% to 80% by weight, such as 50% to 75% by weight, such as 60% to 90% by weight, such as 60% to 80% by weight, such as 60% to 75% by weight, based on the total weight of the resin solids of the electrodepositable coating composition.

The cationic salt-group-containing, film-forming resin may be an auxiliary resin. As used herein, an “auxiliary resin” refers to a resinous component that is not the dominant resin component of the composition and comprises less than 50% by weight of the resin solids of the electrodepositable coating composition, not counting the curing agent. An auxiliary resin may be present in an amount of less than 50% by weight of the resin solids of the electrodepositable coating composition, not counting the curing agent, such as less than 40% by weight, such as less than 30% by weight, such as less than 20% by weight, such as less than 10% by weight, such as less than 5% by weight.

If present as an auxiliary resin, the cationic salt-group-containing, film-forming resin may be present in an amount of at least 1% by weight, such as at least 3% by weight, such as at least 5% by weight, such as at least 10% by weight, based on the total weight of the resin solids of the electrodepositable coating composition. If present as an auxiliary resin, the cationic salt-group-containing, film-forming resin may be present in an amount of no more than 39% by weight, such as no more than 25% by weight, such as no more than 15% by weight, such as no more than 10% by weight, such as no more than 5% by weight, based on the total weight of the resin solids of the electrodepositable coating composition. If present as an auxiliary resin, the cationic salt-group-containing, film-forming resin may be present in an amount of 1% to 39% by weight, such as 1% to 25% by weight, such as 1% to 15% by weight, such as 1% to 10% by weight, such as 1% to 5% by weight, such as 3% to 39% by weight, such as 3% to 25% by weight, such as 3% to 15% by weight, such as 3% to 10% by weight, such as 3% to 5% by weight, such as 5% to 39% by weight, such as 5% to 25% by weight, such as 5% to 15% by weight, such as 5% to 10% by weight, such as 10% to 39% by weight, such as 10% to 25% by weight, such as 10% to 15% by weight, based on the total weight of the resin solids of the electrodepositable coating composition.

As used herein, the term “resin solid” or “resin solids” includes the cationic salt-group-containing, film-forming resin, the curing agent, the second cationic salt-group-containing, film-forming resin, if present, and any additional water-dispersible non-pigmented component(s) present in the electrodepositable coating composition.

### Second Cationic Salt-Group-Containing, Salt Group-Containing Film-Forming Resin

According to the present disclosure, the electrodepositable coating composition may further comprise a second cationic salt-group-containing, film-forming resin different than the cationic salt-group-containing, film-forming resin described above.

The second cationic salt group-containing film-forming resin may be used in a cationic electrodepositable coating composition. The second cationic salt group-containing film-forming polymer may comprise active hydrogen functional groups. As used herein, the term “active hydrogen functional groups” refers to those groups that are reactive with isocyanates as determined by the Zerewitinoff test described in the JOURNAL OF THE AMERICAN CHEMICAL SOCIETY, Vol. 49, page 3181 (1927), and include, for example, hydroxyl groups, primary or secondary amino groups, and thiol groups. Cationic salt group-containing film-forming polymers that comprise active hydrogen functional groups may be referred to as active hydrogen-containing, cationic salt group-containing film-forming polymers.

Examples of polymers that are suitable for use as the second cationic salt group-containing film-forming resin in the present disclosure include, but are not limited to, alkyd polymers, acrylics, polyepoxides, polyamides, polyurethanes, polyureas, polyethers, and polyesters, among others.

More specific examples of suitable active hydrogen-containing, second cationic salt group containing film-forming resins include polyepoxide-amine adducts, such as the adduct of a polyglycidyl ethers of a polyphenol, such as Bisphenol A, and primary and/or secondary amines, such as are described in U.S. Pat. No. 4,031,050 at col. 3, line 27 to col. 5, line 50, U.S. Pat. No. 4,452,963 at col. 5, line 58 to col. 6, line 66, and U.S. Pat. No. 6,017,432 at col. 2, line 66 to col. 6, line 26, these portions of which being incorporated herein by reference. A portion of the amine that is reacted with the polyepoxide may be a ketimine of a polyamine, as is described in U.S. Pat. No. 4,104,147 at col. 6, line 23 to col. 7, line 23, the cited portion of which being incorporated herein by reference. Also suitable are ungelled polyepoxide-polyoxyalkylenepolyamine resins, such as are described in U.S. Pat. No. 4,432,850 at col. 2, line 60 to col. 5, line 58, the cited portion of which being incorporated herein by reference. In addition, cationic acrylic resins, such as those described in U.S. Pat. No. 3,455,806 at col. 2, line 18 to col. 3, line 61 and U.S. Pat. No. 3,928,157 at col. 2, line 29 to col. 3, line 21, these portions of both of which are incorporated herein by reference, may be used.

Besides amine salt group-containing resins, quaternary ammonium salt group-containing resins may also be employed as a second cationic salt group-containing film-forming resin. Examples of these resins are those which are formed from reacting an organic polyepoxide with a tertiary amine acid salt. Such resins are described in U.S. Pat. No. 3,962,165 at col. 2, line 3 to col. 11, line 7; U.S. Pat. No. 3,975,346 at col. 1, line 62 to col. 17, line 25 and U.S. Pat. No. 4,001,156 at col. 1, line 37 to col. 16, line 7, these portions of which being incorporated herein by reference. Examples of other suitable cationic resins include ternary sulfonium salt group-containing resins, such as those described in U.S. Pat. No. 3,793,278 at col. 1, line 32 to col. 5, line 20, this portion of which being incorporated herein by reference. Also, cationic resins which cure via a transesterification mechanism, such as described in European Pat. Application No. 12463B1 at pg. 2, line 1 to pg. 6, line 25, this portion of which being incorporated herein by reference, may also be employed.

Other suitable second cationic salt group-containing film-forming resins include those that may form photodegradation resistant electrodepositable coating compositions. Such polymers include the polymers comprising cationic amine salt groups which are derived from pendant and/or terminal amino groups that are disclosed in U.S. Pat. Application Publication No. 2003/0054193 A1 at paragraphs [0064] to [0088], this portion of which being incorporated herein by reference. Also suitable are the active hydrogen-containing, second cationic salt group-containing resins derived from a polyglycidyl ether of a polyhydric phenol that is essentially free of aliphatic carbon atoms to which are covalently bonded more than one aromatic group, which are described in U.S. Pat. Application Publication No. 2003/0054193 A1 at paragraphs [0096] to [0123], this portion of which being incorporated herein by reference.

The cationic salt group-containing film-forming resins may be made cationic and water dispersible by at least partial neutralization with an acid. Suitable acids include organic and inorganic acids. Non-limiting examples of suitable organic acids include formic acid, acetic acid, methanesulfonic acid, and lactic acid. Non-limiting examples of suitable inorganic acids include phosphoric acid and sulfamic acid. By “sulfamic acid” is meant sulfamic acid itself or derivatives thereof having the formula:

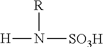

wherein R is hydrogen or an alkyl group having 1 to 4 carbon atoms. Mixtures of the above-mentioned acids also may be used in the present disclosure.

The extent of neutralization of the cationic salt group-containing film-forming resins may vary with the particular polymer involved. However, sufficient acid should be used to sufficiently neutralize the cationic salt-group containing film-forming polymer such that the cationic salt-group containing film-forming polymer may be dispersed in an aqueous dispersing medium. For example, the amount of acid used may provide at least 20% of all of the total theoretical neutralization. Excess acid may also be used beyond the amount required for 100% total theoretical neutralization. For example, the amount of acid used to neutralize the cationic salt group-containing film-forming polymer may be ≥0.1% based on the total amines in the active hydrogen-containing, cationic salt group-containing film-forming polymer. Alternatively, the amount of acid used to neutralize the active hydrogen-containing, cationic salt group-containing film-forming polymer may be ≤100% based on the total amines in the active hydrogen-containing, cationic salt group-containing film-forming polymer. The total amount of acid used to neutralize the cationic salt group-containing film-forming polymer may range between any combination of values, which were recited in the preceding sentences, inclusive of the recited values. For example, the total amount of acid used to neutralize the active hydrogen-containing, cationic salt group-containing film-forming polymer may be 20%, 35%, 50%, 60%, or 80% based on the total amines in the cationic salt group-containing film-forming polymer.

The second cationic salt-group-containing, film-forming resin may be present as a main vehicle resin or as an auxiliary resin.

If present as a main vehicle resin, the second cationic salt-group-containing, film-forming resin may be present in an amount of at least 40% by weight, such as at least 50% by weight, such as at least 60% by weight, based on the total weight of the resin solids of the electrodepositable coating composition. If present as a main vehicle resin, the second cationic salt-group-containing, film-forming resin may be present in an amount of no more than 89% by weight, such as no more than 80% by weight, such as no more than 75% by weight, based on the total weight of the resin solids of the electrodepositable coating composition. If present as a main vehicle resin, the second cationic salt-group-containing, film-forming resin may be present in an amount of 40% to 89% by weight, such as 40% to 80% by weight, such as 40% to 75% by weight, such as 50% to 89% by weight, such as 50% to 80% by weight, such as 50% to 75% by weight, such as 60% to 89% by weight, such as 60% to 80% by weight, such as 60% to 75% by weight, based on the total weight of the resin solids of the electrodepositable coating composition.

If present as an auxiliary resin, the second cationic salt-group-containing, film-forming resin may be present in an amount of at least 1% by weight, such as at least 3% by weight, such as at least 5% by weight, such as at least 10% by weight, based on the total weight of the resin solids of the electrodepositable coating composition. If present as an auxiliary resin, the second cationic salt-group-containing, film-forming resin may be present in an amount of no more than 39% by weight, such as no more than 25% by weight, such as no more than 15% by weight, such as no more than 10% by weight, such as no more than 5% by weight, based on the total weight of the resin solids of the electrodepositable coating composition. If present as an auxiliary resin, the second cationic salt-group-containing, film-forming resin may be present in an amount of 1% to 39% by weight, such as 1% to 25% by weight, such as 1% to 15% by weight, such as 1% to 10% by weight, such as 1% to 5% by weight, such as 3% to 39% by weight, such as 3% to 25% by weight, such as 3% to 15% by weight, such as 3% to 10% by weight, such as 3% to 5% by weight, such as 5% to 39% by weight, such as 5% to 25% by weight, such as 5% to 15% by weight, such as 5% to 10% by weight, such as 10% to 39% by weight, such as 10% to 25% by weight, such as 10% to 15% by weight, based on the total weight of the resin solids of the electrodepositable coating composition.

### Curing Agent

According to the present disclosure, the electrodepositable coating composition of the present disclosure may further comprise a curing agent. The curing agent is reactive with the ionic salt group-containing film-forming polymer. The curing agent may react with the reactive groups, such as active hydrogen groups, of the ionic salt group-containing film-forming polymer to effectuate cure of the coating composition to form a coating. As used herein, the term “cure”, “cured” or similar terms, as used in connection with the electrodepositable coating compositions described herein, means that at least a portion of the components that form the electrodepositable coating composition are crosslinked to form a coating. Additionally, curing of the electrodepositable coating composition refers to subjecting said composition to curing conditions (e.g., elevated temperature) leading to the reaction of the reactive functional groups of the components of the electrodepositable coating composition, and resulting in the crosslinking of the components of the composition and formation of an at least partially cured coating. Non-limiting examples of suitable curing agents are at least partially blocked polyisocyanates, aminoplast resins and phenoplast resins, such as phenolformaldehyde condensates including allyl ether derivatives thereof.

Suitable at least partially blocked polyisocyanates include aliphatic polyisocyanates, aromatic polyisocyanates, and mixtures thereof. The curing agent may comprise an at least partially blocked aliphatic polyisocyanate. Suitable at least partially blocked aliphatic polyisocyanates include, for example, fully blocked aliphatic polyisocyanates, such as those described in U.S. Pat. No. 3,984,299 at col. 1 line 57 to col. 3 line 15, this portion of which is incorporated herein by reference, or partially blocked aliphatic polyisocyanates that are reacted with the polymer backbone, such as is described in U.S. Pat. No. 3,947,338 at col. 2 line 65 to col. 4 line 30, this portion of which is also incorporated herein by reference. By “blocked” is meant that the isocyanate groups have been reacted with a compound such that the resultant blocked isocyanate group is stable to active hydrogens at ambient temperature (23° C.) but reactive with active hydrogens in the film forming polymer at elevated temperatures, such as between 90° C. and 200° C. The polyisocyanate curing agent may be a fully blocked polyisocyanate with substantially no free isocyanate groups at ambient temperature.

The polyisocyanate curing agent may comprise a diisocyanate, higher functional polyisocyanates or combinations thereof. For example, the polyisocyanate curing agent may comprise aliphatic and/or aromatic polyisocyanates. Aliphatic polyisocyanates may include (i) alkylene isocyanates, such as trimethylene diisocyanate, tetramethylene diisocyanate, pentamethylene diisocyanate, hexamethylene diisocyanate (“HDI”), 1,2-propylene diisocyanate, 1,2-butylene diisocyanate, 2,3-butylene diisocyanate, 1,3-butylene diisocyanate, ethylidene diisocyanate, and butylidene diisocyanate, and (ii) cycloalkylene isocyanates, such as 1,3-cyclopentane diisocyanate, 1,4-cyclohexane diisocyanate, 1,2-cyclohexane diisocyanate, isophorone diisocyanate, methylene bis(4-cyclohexylisocyanate) (“HMDI”), the cyclo-trimer of 1,6-hexmethylene diisocyanate (also known as the isocyanurate trimer of HDI, commercially available as Desmodur N3300 from Convestro AG), and meta-tetramethylxylylene diisocyanate (commercially available as TMXDI® from Allnex SA). Aromatic polyisocyanates may include (i) arylene isocyanates, such as m-phenylene diisocyanate, p-phenylene diisocyanate, 1,5-naphthalene diisocyanate and 1,4-naphthalene diisocyanate, and (ii) alkarylene isocyanates, such as 4,4′-diphenylene methane (“MDI”), 2,4-tolylene or 2,6-tolylene diisocyanate (“TDI”), or mixtures thereof, 4,4-toluidine diisocyanate and xylylene diisocyanate. Triisocyanates, such as triphenyl methane-4,4′,4″-triisocyanate, 1,3,5-triisocyanato benzene and 2,4,6-triisocyanato toluene, tetraisocyanates, such as 4,4′-diphenyldimethyl methane-2,2′,5,5′-tetraisocyanate, and polymerized polyisocyanates, such as tolylene diisocyanate dimers and trimers and the like, may also be used. The curing agent may comprise a blocked polyisocyanate selected from a polymeric polyisocyanate, such as polymeric HDI, polymeric MDI, polymeric isophorone diisocyanate, and the like. The curing agent may also comprise a blocked trimer of hexamethylene diisocyanate available as Desmodur N3300® from Covestro AG. Mixtures of polyisocyanate curing agents may also be used.

The blocked polyisocyanate curing agent may comprise a tris(alkoxycarbonylamino)-1,3,5-triazine (TACT). The tris(alkoxycarbonylamino)-1,3,5-triazine may be according to the following structure:

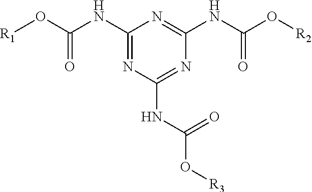

wherein R₁, R₂, and R₃ each independently comprise a C₁-C₈ alkyl group, such as a C₁-C₆ alkyl group, such as a C₁-C₄ alkyl group. In a non-limiting example, R₁ and R₂ are each methyl and R₃ is n-butyl, or R₁ and R₂ are each n-butyl and R₃ methyl. In a non-limiting example, each of the radicals R₁, R₂, and R₃ is n-butyl. Examples of suitable tris(alkoxycarbonylamino)-1,3,5-triazines include tris(methoxycarbonylamino)-, tris(butoxycarbonylamino)-, and tris(2-ethylhexoxycarbonylamino)-1,3,5-triazines, and any combination thereof.

The polyisocyanate curing agent may be at least partially blocked with at least one blocking agent selected from a 1,2-alkane diol, for example 1,2-propanediol; a 1,3-alkane diol, for example 1,3-butanediol; a benzylic alcohol, for example, benzyl alcohol; an allylic alcohol, for example, allyl alcohol; caprolactam; a dialkylamine, for example dibutylamine; and mixtures thereof. The polyisocyanate curing agent may be at least partially blocked with at least one 1,2-alkane diol having three or more carbon atoms, for example 1,2-butanediol.

Other suitable blocking agents include aliphatic, cycloaliphatic, or aromatic alkyl monoalcohols or phenolic compounds, including, for example, lower aliphatic alcohols, such as methanol, ethanol, and n-butanol; cycloaliphatic alcohols, such as cyclohexanol; aromatic-alkyl alcohols, such as phenyl carbinol and methylphenyl carbinol; and phenolic compounds, such as phenol itself and substituted phenols wherein the substituents do not affect coating operations, such as cresol and nitrophenol. Glycol ethers and glycol amines may also be used as blocking agents. Suitable glycol ethers include ethylene glycol butyl ether, diethylene glycol butyl ether, ethylene glycol methyl ether and propylene glycol methyl ether. Other suitable blocking agents include oximes, such as methyl ethyl ketoxime, acetone oxime and cyclohexanone oxime; dialkylpyrazole, acetoacetate; and/or dialkyl malonate.

The curing agent may comprise an aminoplast resin. Aminoplast resins are condensation products of an aldehyde with an amino- or amido-group carrying substance. Condensation products obtained from the reaction of alcohols and an aldehyde with melamine, urea or benzoguanamine may be used. However, condensation products of other amines and amides may also be employed, for example, aldehyde condensates of triazines, diazines, triazoles, guanidines, guanamines and alkyl- and aryl-substituted derivatives of such compounds, including alkyl- and aryl-substituted ureas and alkyl- and aryl-substituted melamines. Some examples of such compounds are N,N′-dimethyl urea, benzourea, dicyandiamide, formaguanamine, acetoguanamine, ammeline, 2-chloro-4,6-diamino-1,3,5-triazine, 6-methyl-2,4-diamino-1,3,5-triazine, 3,5-diaminotriazole, triaminopyrimidine, 2-mercapto-4,6-diaminopyrimidine, 3,4,6-tris(ethylamino)-1,3,5-triazine, and the like. Suitable aldehydes include formaldehyde, acetaldehyde, crotonaldehyde, acrolein, benzaldehyde, furfural, glyoxal and the like.

The aminoplast resins may contain methylol or similar alkylol groups, and at least a portion of these alkylol groups may be etherified by a reaction with an alcohol to provide organic solvent-soluble resins. Any monohydric alcohol may be employed for this purpose, including such alcohols as methanol, ethanol, propanol, butanol, pentanol, hexanol, heptanol and others, as well as benzyl alcohol and other aromatic alcohols, cyclic alcohol such as cyclohexanol, monoethers of glycols such as Cello solves and Carbitols, and halogen-substituted or other substituted alcohols, such as 3-chloropropanol and butoxyethanol.

Non-limiting examples of commercially available aminoplast resins are those available under the trademark CYMEL® from Allnex Belgium SA/NV, such as CYMEL 1130 and 1156, and RESIMENE® from INEOS Melamines, such as RESIMENE 750 and 753. Examples of suitable aminoplast resins also include those described in U.S. Pat. No. 3,937,679 at col. 16, line 3 to col. 17, line 47, this portion of which being hereby incorporated by reference. As is disclosed in the aforementioned portion of the '679 patent, the aminoplast may be used in combination with the methylol phenol ethers.

Phenoplast resins are formed by the condensation of an aldehyde and a phenol. Suitable aldehydes include formaldehyde and acetaldehyde. Methylene-releasing and aldehyde-releasing agents, such as paraformaldehyde and hexamethylene tetramine, may also be utilized as the aldehyde agent. Various phenols may be used, such as phenol itself, a cresol, or a substituted phenol in which a hydrocarbon radical having either a straight chain, a branched chain or a cyclic structure is substituted for a hydrogen in the aromatic ring. Mixtures of phenols may also be employed. Some specific examples of suitable phenols are p-phenylphenol, p-tert-butylphenol, p-tert-amylphenol, cyclopentylphenol and unsaturated hydrocarbon-substituted phenols, such as the monobutenyl phenols containing a butenyl group in ortho, meta or para position, and where the double bond occurs in various positions in the hydrocarbon chain.

Aminoplast and phenoplast resins, as described above, are described in U.S. Pat. No. 4,812,215 at col. 6, line 20 to col. 7, line 12, the cited portion of which being incorporated herein by reference.

The curing agent may be present in the cationic electrodepositable coating composition in an amount of at least 10% by weight, such as at least 20% by weight, such as at least 25% by weight and may be present in an amount of no more than 60% by weight, such as no more than 59.95% by weight, such as no more than 50% by weight, such as no more than 40% by weight, based on the total weight of the resin solids of the electrodepositable coating composition. The curing agent may be present in the cationic electrodepositable coating composition in an amount of 10% to 60% by weight, such as 10% to 59.95% by weight, such as 20% to 50% by weight, such as 25% to 40% by weight, based on the total weight of the resin solids of the electrodepositable coating composition.

### Further Components of the Electrodepositable Coating Compositions

The electrodepositable coating composition according to the present disclosure may optionally comprise one or more further components in addition to the ionic salt group-containing film-forming polymer and the curing agent described above.

According to the present disclosure, the electrodepositable coating composition may optionally comprise a catalyst to catalyze the reaction between the curing agent and the polymers. Examples of catalysts suitable for cationic electrodepositable coating compositions include, without limitation, organotin compounds (e.g., dibutyltin oxide and dioctyltin oxide) and salts thereof (e.g., dibutyltin diacetate); other metal oxides (e.g., oxides of cerium, zirconium and bismuth) and salts thereof (e.g., bismuth sulfamate and bismuth lactate); or a cyclic guanidine as described in U.S. Pat. No. 7,842,762 at col. 1, line 53 to col. 4, line 18 and col. 16, line 62 to col. 19, line 8, the cited portions of which being incorporated herein by reference. During cure, the catalysts may be activated, for example, by heating.

According to the present disclosure, the electrodepositable coating compositions of the present disclosure may optionally comprise crater control additives which may be incorporated into the coating composition, such as, for example, a polyalkylene oxide polymer which may comprise a copolymer of butylene oxide and propylene oxide. According to the present disclosure, the molar ratio of butylene oxide to propylene oxide may be at least 1:1, such as at least 3:1, such as at least 5:1, and in some instances, may be no more than 50:1, such as no more than 30:1, such as no more than 20:1. According to the present disclosure, the molar ratio of butylene oxide to propylene oxide may be 1:1 to 50:1, such as 3:1 to 30:1, such as 5:1 to 20:1.

The polyalkylene oxide polymer may comprise at least two hydroxyl functional groups, and may be monofunctional, difunctional, trifunctional, or tetrafunctional. As used herein, a “hydroxyl functional group” comprises an —OH group. For clarity, the polyalkylene oxide polymer may comprise additional functional groups in addition to the hydroxyl functional group(s). As used herein, “monofunctional,” when used with respect to the number of hydroxyl functional groups a particular monomer or polymer comprises, means a monomer or polymer comprising one (1) hydroxyl functional group per molecule. As used herein, “difunctional,” when used with respect to the number of hydroxyl functional groups a particular monomer or polymer comprises, means a monomer or polymer comprising two (2) hydroxyl functional groups per molecule. As used herein, “trifunctional,” when used with respect to the number of hydroxyl functional groups a particular monomer or polymer comprises, means a monomer or polymer comprising three (3) hydroxyl functional groups per molecule. As used herein, “tetrafunctional,” when used with respect to the number of hydroxyl functional groups a particular monomer or polymer comprises, means a monomer or polymer comprising four (4) hydroxyl functional groups per molecule.

The hydroxyl equivalent weight of the polyalkylene oxide polymer may be at least 100 g/mol, such as at least 200 g/mol, such as at least 400 g/mol, and may be no more than 2,000 g/mol, such as no more than 1,000 g/mol, such as no more than 800 g/mol. The hydroxyl equivalent weight of the polyalkylene oxide polymer may be 100 g/mol to 2,000 g/mol, such as 200 g/mol to 1,000 g/mol, such as 400 g/mol to 800 g/mol. As used herein, with respect to the polyalkylene oxide polymer, the “hydroxyl equivalent weight” is determined by dividing the molecular weight of the polyalkylene oxide polymer by the number of hydroxyl groups present in the polyalkylene oxide polymer.

The polyalkylene oxide polymer may have a z-average molecular weight (M_{z}) of at least 200 g/mol, such as at least 400 g/mol, such as at least 600 g/mol, and may be no more than 5,000 g/mol, such as no more than 3,000 g/mol, such as no more than 2,000 g/mol. According to the present disclosure, the polyalkylene oxide polymer may have a z-average molecular weight of 200 g/mol to 5,000 g/mol, such as 400 g/mol to 3,000 g/mol, such as 600 g/mol to 2,000 g/mol. As used herein, with respect to polyalkylene oxide polymers having a z-average molecular weight (M_{z}) of less than 900,000, the term “z-average molecular weight (M_{z})” means the z-average molecular weight (M_{z}) as determined by Gel Permeation Chromatography using Waters 2695 separation module with a Waters 410 differential refractometer (RI detector), polystyrene standards having molecular weights of from approximately 500 g/mol to 900,000 g/mol, tetrahydrofuran (THF) with 0.05 M lithium bromide (LiBr) as the eluent at a flow rate of 0.5 mL/min, and one Asahipak GF-510 HQ column for separation.

The polyalkylene oxide polymer may be present in the electrodepositable coating composition in an amount of at least 0.1% by weight based on the total weight of the resin blend solids, such as at least 0.5% by weight, such as at least 0.75% by weight, and in some instances, may be present in the electrodepositable coating composition in an amount of no more than 10% by weight based on the total weight of the resin blend solids, such as no more than 4% by weight, such as no more than 3% by weight. The polyalkylene oxide polymer may be present in the electrodepositable coating composition in an amount of at 0.1% by weight to 10% by weight based on the total weight of the resin blend solids, such as 0.5% by weight to 4% by weight, such as 0.75% by weight to 3% by weight.

The electrodepositable coating composition may be substantially free, essentially free, or completely free of bisphenol A polyoxyethylene ether phosphate. As used herein, the term “substantially free” means that bisphenol A polyoxyethylene ether phosphate is present, if at all, in an amount of less than 5% by weight, based on the total weight of the resin solids. As used herein, the term “essentially free” means that bisphenol A polyoxyethylene ether phosphate is present, if at all, in an amount of less than 1% by weight, based on the total weight of the resin solids. As used herein, the term “completely free” means that bisphenol A polyoxyethylene ether phosphate is not present, i.e., 0.00% by weight, based on the total weight of the resin solids.

According to the present disclosure, the electrodepositable coating composition may comprise other optional ingredients, such as, if desired, various additives such as fillers, plasticizers, antioxidants, biocides, UV light absorbers and stabilizers, hindered amine light stabilizers, defoamers, fungicides, dispersing aids, flow control agents, surfactants, wetting agents, or combinations thereof. Alternatively, the electrodepositable coating composition may be completely free of any of the optional ingredients, i.e., the optional ingredient is not present in the electrodepositable coating composition. The additives mentioned above may be present in the electrodepositable coating composition in amounts of 0.01% to 3% by weight, based on total weight of the resin solids of the electrodepositable coating composition.

The electrodepositable coating composition may optionally further comprise a pigment. The pigment may comprise an iron oxide, a lead oxide, strontium chromate, carbon black, coal dust, titanium dioxide, talc, barium sulfate, a phyllosilicate pigment, a metal pigment, a thermally conductive, electrically insulative filler, fire-retardant pigment, as well as color pigments such as cadmium yellow, cadmium red, chromium yellow and the like, or any combination thereof.

The pigment-to-binder (P:B) ratio as set forth in this disclosure may refer to the weight ratio of the pigment-to-binder in the electrodepositable coating composition, and/or the weight ratio of the pigment-to-binder in the deposited wet film, and/or the weight ratio of the pigment to the binder in the dry, uncured deposited film, and/or the weight ratio of the pigment-to-binder in the cured film. The pigment-to-binder (P:B) ratio of the pigment to the electrodepositable binder may be at least 0.05:1, such as at least 0.1:1, such as at least 0.2:1, such as at least 0.30:1, such as at least 0.35:1, such as at least 0.40:1, such as at least 0.50:1, such as at least 0.60:1, such as at least 0.75:1, such as at least 1:1, such as at least 1.25:1, such as at least 1.5:1. The pigment-to-binder (P:B) ratio of the pigment to the electrodepositable binder may be no more than 2.0:1, such as no more than 1.75:1, such no more than 1.5:1, such as no more than 1.25:1, such as no more than 1:1, such as no more than 0.75:1, such as no more than 0.70:1, such as no more than 0.60:1, such as no more than 0.55:1, such as no more than 0.50:1, such as no more than 0.30:1, such as no more than 0.20:1, such as no more than 0.10:1. The pigment-to-binder (P:B) ratio of the pigment to the electrodepositable binder may be 0.05:1 to 2.0:1, such as 0.05:1 to 1.75:1, such as 0.05:1 to 1.50:1, such as 0.05:1 to 1.25:1, such as 0.05:1 to 1:1, such as 0.05:1 to 0.75:1, such as 0.05:1 to 0.70:1, such as 0.05:1 to 0.60:1, such as 0.05:1 to 0.55:1, such as 0.05:1 to 0.50:1, such as 0.05:1 to 0.30:1, such as 0.05:1 to 0.20:1, such as 0.05:1 to 0.10:1, such as 0.1:1 to 2.0:1, such as 0.1:1 to 1.75:1, such as 0.1:1 to 1.50:1, such as 0.1:1 to 1.25:1, such as 0.1:1 to 1:1, such as 0.1:1 to 0.75:1, such as 0.1:1 to 0.70:1, such as 0.1:1 to 0.60:1, such as 0.1:1 to 0.55:1, such as 0.1:1 to 0.50:1, such as 0.1:1 to 0.30:1, such as 0.1:1 to 0.20:1, such as 0.2:1 to 2.0:1, such as 0.2:1 to 1.75:1, such as 0.2:1 to 1.50:1, such as 0.2:1 to 1.25:1, such as 0.2:1 to 1:1, such as 0.2:1 to 0.75:1, such as 0.2:1 to 0.70:1, such as 0.2:1 to 0.60:1, such as 0.2:1 to 0.55:1, such as 0.2:1 to 0.50:1, such as 0.2:1 to 0.30:1, such as 0.3:1 to 2.0:1, such as 0.3:1 to 1.75:1, such as 0.3:1 to 1.50:1, such as 0.3:1 to 1.25:1, such as 0.3:1 to 1:1, such as 0.3:1 to 0.75:1, such as 0.3:1 to 0.70:1, such as 0.3:1 to 0.60:1, such as 0.3:1 to 0.55:1, such as 0.3:1 to 0.50:1, such as 0.3:1 to 0.30:1, such as 0.35:1 to 2.0:1, such as 0.35:1 to 1.75:1, such as 0.35:1 to 1.50:1, such as 0.35:1 to 1.25:1, such as 0.35:1 to 1:1, such as 0.35:1 to 0.75:1, such as 0.35:1 to 0.70:1, such as 0.35:1 to 0.60:1, such as 0.35:1 to 0.55:1, such as 0.35:1 to 0.50:1, such as 0.4:1 to 2.0:1, such as 0.4:1 to 1.75:1, such as 0.4:1 to 1.50:1, such as 0.4:1 to 1.25:1, such as 0.4:1 to 1:1, such as 0.4:1 to 0.75:1, such as 0.4:1 to 0.70:1, such as 0.4:1 to 0.60:1, such as 0.4:1 to 0.55:1, such as 0.4:1 to 0.50:1, such as 0.5:1 to 2.0:1, such as 0.5:1 to 1.75:1, such as 0.5:1 to 1.50:1, such as 0.5:1 to 1.25:1, such as 0.5:1 to 1:1, such as 0.5:1 to 0.75:1, such as 0.5:1 to 0.70:1, such as 0.5:1 to 0.60:1, such as 0.5:1 to 0.55:1, such as 0.6:1 to 2.0:1, such as 0.6:1 to 1.75:1, such as 0.6:1 to 1.50:1, such as 0.6:1 to 1.25:1, such as 0.6:1 to 1:1, such as 0.6:1 to 0.75:1, such as 0.6:1 to 0.70:1, such as 0.75:1 to 2.0:1, such as 0.75:1 to 1.75:1, such as 0.75:1 to 1.50:1, such as 0.75:1 to 1.25:1, such as 0.75:1 to 1:1, such as 1:1 to 2.0:1, such as 1:1 to 1.75:1, such as 1:1 to 1.50:1, such as 1:1 to 1.25:1, such as 1.25:1 to 2.0:1, such as 1.25:1 to 1.75:1, such as 1.25:1 to 1.50:1, such as 1.50:1 to 2.0:1, such as 1.50:1 to 1.75:1.

According to the present disclosure, the electrodepositable coating composition may comprise water and/or one or more organic solvent(s). Water can for example be present in amounts of 40% to 90% by weight, such as 50% to 75% by weight, based on total weight of the electrodepositable coating composition. Examples of suitable organic solvents include oxygenated organic solvents, such as monoalkyl ethers of ethylene glycol, diethylene glycol, propylene glycol, and dipropylene glycol which contain from 1 to 10 carbon atoms in the alkyl group, such as the monoethyl and monobutyl ethers of these glycols. Examples of other at least partially water-miscible solvents include alcohols such as ethanol, isopropanol, butanol and diacetone alcohol. If used, the organic solvents may typically be present in an amount of less than 10% by weight, such as less than 5% by weight, based on total weight of the electrodepositable coating composition. The electrodepositable coating composition may in particular be provided in the form of a dispersion, such as an aqueous dispersion.

According to the present disclosure, the total solids content of the electrodepositable coating composition may be at least 1% by weight, such as at least 5% by weight, and may be no more than 50% by weight, such as no more than 40% by weight, such as no more than 20% by weight, based on the total weight of the electrodepositable coating composition. The total solids content of the electrodepositable coating composition may be from 1% to 50% by weight, such as 5% to 40% by weight, such as 5% to 20% by weight, based on the total weight of the electrodepositable coating composition. As used herein, “total solids” refers to the non-volatile content of the electrodepositable coating composition, i.e., materials which will not volatilize when heated to 110° C. for 15 minutes.

The electrodepositable coating composition may have a free-bisphenol A content of less than 0.1% by weight, as measured by HPLC or LC-MS, based on the total weight of the electrodepositable coating composition, such as less than 0.01% by weight, such as less than 0.001% by weight. As used herein, “free-bisphenol A” refers to bisphenol A in an unreacted form wherein neither hydroxyl group of the bisphenol A has reacted with the functional group of another molecule.

The free-BPA level for an electrodepositable coating composition may be determined by HPLC.

The free-bisphenol A level for an electrodepositable coating composition having a free-BPA level of <0.01 as measured by HPLC may be further analyzed by LC-MS to get a more precise value.

### Substrates

According to the present disclosure, the electrodepositable coating composition may be electrophoretically applied to an electrically conductive substrate. The electrodepositable coating composition may be electrophoretically deposited upon any electrically conductive substrate. Suitable substrates include metal substrates, metal alloy substrates, and/or substrates that have been metallized, such as nickel-plated plastic.

Additionally, substrates may comprise non-metal conductive materials including composite materials such as, for example, materials comprising carbon fibers or conductive carbon. According to the present disclosure, the metal or metal alloy may comprise cold rolled steel, hot rolled steel, stainless steel, steel coated with zinc metal, zinc compounds, or zinc alloys, such as electrogalvanized steel, hot-dipped galvanized steel, galvannealed steel, and steel plated with zinc alloy. Aluminum alloys of the 2XXX, 3XXX, 4XXX, 5XXX, 6XXX, or 7XXX series as well as clad aluminum alloys and cast aluminum alloys of the A356 series also may be used as the substrate. Magnesium alloys of the AZ31B, AZ91C, AM60B, or EV31A series also may be used as the substrate. The substrate used in the present disclosure may also comprise titanium and/or titanium alloys. Other suitable non-ferrous metals include copper and magnesium, as well as alloys of these materials. Suitable metal substrates for use in the present disclosure include those that are often used in the assembly of vehicular bodies (e.g., without limitation, door, body panel, trunk deck lid, roof panel, hood, roof and/or stringers, rivets, landing gear components, and/or skins used on an aircraft), a vehicular frame, vehicular parts, motorcycles, wheels, industrial structures and components such as appliances, including washers, dryers, refrigerators, stoves, dishwashers, and the like, agricultural equipment, lawn and garden equipment, air conditioning units, heat pump units, lawn furniture, and other articles. As used herein, “vehicle” or variations thereof includes, but is not limited to, civilian, commercial and military aircraft, and/or land vehicles such as cars, motorcycles, trucks, tanks, and/or armored cars or trucks. The metal substrate also may be in the form of, for example, a sheet of metal or a fabricated part. It will also be understood that the substrate may be pretreated with a pretreatment solution including a zinc phosphate pretreatment solution such as, for example, those described in U.S. Pat. Nos. 4,793,867 and 5,588,989, or a zirconium containing pretreatment solution such as, for example, those described in U.S. Pat. Nos. 7,749,368 and 8,673,091.

The substrate may be a multi-metal article. As used herein, the term “multi-metal article” refers to (1) an article that has at least one surface comprised of a first metal and at least one surface comprised of a second metal that is different from the first metal, (2) a first article that has at least one surface comprised of a first metal and a second article that has at least one surface comprised of a second metal that is different from the first metal, or (3) both (1) and (2). The substrate may comprise surfaces or parts of different substrate materials that are adjacent or joined together such as, for example, a galvanic assembly.

### Methods of Coating, Coatings and Coated Substrates

The present disclosure is also directed to methods for coating a substrate, such as any one of the electroconductive substrates mentioned above. The method may comprise electrophoretically applying an electrodepositable coating composition as described above to at least a portion of the substrate and curing the coating composition to form an at least partially cured coating on the substrate. The method may comprise (a) electrophoretically depositing onto at least a portion of the substrate an electrodepositable coating composition of the present disclosure and (b) heating the coated substrate to a temperature and for a time sufficient to cure the electrodeposited coating on the substrate. The method may optionally further comprise (c) applying directly to the at least partially cured electrodeposited coating one or more pigment-containing coating compositions and/or one or more pigment-free coating compositions to form a topcoat over at least a portion of the at least partially cured electrodeposited coating, and (d) heating the coated substrate of step (c) to a temperature and for a time sufficient to cure the topcoat.

The cationic electrodepositable coating composition may be deposited upon an electrically conductive substrate by placing the composition in contact with an electrically conductive cathode and an electrically conductive anode, with the surface to be coated being the cathode. Following contact with the composition, an adherent film of the coating composition is deposited on the cathode when a sufficient voltage is impressed between the electrodes. The conditions under which the electrodeposition is carried out are, in general, similar to those used in electrodeposition of other types of coatings. The applied voltage may be varied and can be, for example, as low as one volt to as high as several thousand volts, such as between 50 and 500 volts. The current density may be between 0.5 ampere and 15 amperes per square foot and tends to decrease during electrodeposition indicating the formation of an insulating film.

Once the cationic electrodepositable coating composition is electrodeposited over at least a portion of the electroconductive substrate, the coated substrate is heated to a temperature and for a time sufficient to at least partially cure the electrodeposited coating on the substrate. As used herein, the term “at least partially cured” with respect to a coating refers to a coating formed by subjecting the coating composition to curing conditions such that a chemical reaction of at least a portion of the reactive groups of the components of the coating composition occurs to form a coating. The coated substrate may be heated to a temperature ranging from 250° F. to 450° F. (121.1° C. to 232.2° C.), such as from 275° F. to 400° F. (135° C. to 204.4° C.), such as from 300° F. to 360° F. (149° C. to 180° C.). The curing time may be dependent upon the curing temperature as well as other variables, for example, the film thickness of the electrodeposited coating, level and type of catalyst present in the composition and the like. For purposes of the present disclosure, all that is necessary is that the time be sufficient to effect cure of the coating on the substrate. For example, the curing time can range from 10 minutes to 60 minutes, such as 20 to 40 minutes. The thickness of the resultant cured electrodeposited coating may range from 15 to 50 microns.

The electrodepositable coating compositions of the present disclosure may also, if desired, be applied to a substrate using non-electrophoretic coating application techniques, such as flow, dip, spray and roll coating applications. For non-electrophoretic coating applications, the coating compositions may be applied to conductive substrates as well as non-conductive substrates such as glass, wood and plastic.

The present disclosure is further directed to a coating formed by at least partially curing the electrodepositable coating composition described herein.

The present disclosure is further directed to a substrate that is coated, at least in part, with the electrodepositable coating composition described herein in an at least partially cured state.

The present disclosure is further directed to a coated substrate comprising a cured coating film comprising the reaction product of (a) a cationic salt-group-containing, film-forming resin dispersed in an aqueous medium, the cationic salt-group-containing, film-forming resin comprising the reaction product of a reaction mixture comprising (a) a polyepoxide; (b) at least one polyol comprising an aliphatically substituted phenol comprising at least two phenolic hydroxyl groups; and (c) a base; and (b) a curing agent.

### Multi-Layer Coating Composites

The present disclosure is also directed to methods for coating a substrate, such as any one of the electroconductive substrates mentioned above. According to the present disclosure such method may comprise electrophoretically applying an electrodepositable coating composition as described above to at least a portion of the substrate and curing the coating composition to form an at least partially cured coating on the substrate. According to the present disclosure, the method may comprise (a) electrophoretically depositing onto at least a portion of the substrate an electrodepositable coating composition of the present disclosure and (b) heating the coated substrate to a temperature and for a time sufficient to cure the electrodeposited coating on the substrate. According to the present disclosure, the method may optionally further comprise (c) applying directly to the at least partially cured electrodeposited coating one or more pigment-containing coating compositions and/or one or more pigment-free coating compositions to form a topcoat over at least a portion of the at least partially cured electrodeposited coating, and (d) heating the coated substrate of step (c) to a temperature and for a time sufficient to cure the topcoat.

The electrodepositable coating compositions of the present disclosure may comprise a multi-layer coating system. The coating layer deposited from the present composition may have one or more additional coating layers deposited under and/or over the layer. In a non-limiting example, the coating system may comprise a pretreatment layer, such as a phosphate layer (e.g., zinc phosphate layer), and the electrodepositable coating composition described in the present disclosure may be deposited over at least a portion of the pretreated layer; one or more additional coating layers may be applied over at least a portion of the electrodeposited coating layer. In addition to the electrodepositable coating composition of the present disclosure, the coating system may include, for example, one or more pretreatment layers, and one or more additional coating layers comprising primers, basecoats, color coats, monocoats, clear coats and/or topcoats. Suitable additional coating layers include any of those known in the art, and each independently may be waterborne, solventborne, in solid particulate form (i.e., a powder coating composition), or in the form of a powder slurry. The additional coating layers may each be cured independently, or optionally applied “wet-on-wet” and cured simultaneously. As used herein, “wet-on-wet” refers to a process, wherein a coating, for example a clear coat, is applied over a substantially uncured different coating, for example a color coat, and both coatings are then cured simultaneously.

The coating system may optionally comprise one, or a mixture of two or more, of any colorants and/or fillers, as known to those skilled in the art, in any coating layer or layers, in any amounts sufficient to impart the desired property, visual and/or color effect.

The present disclosure is further directed to an electrodeposited coating formed by at least partially curing a film from the electrodepositable coating composition described herein.

The present disclosure is also directed to a coated substrate comprising a coating deposited from the electrodepositable coating composition described above.

The coated substrate may be coated by the method described herein.

The coated conductive substrate optionally may not include, or may be free of, a pretreatment layer between the substrate and the electrodeposited coating.

The coated conductive substrate optionally may not include any intervening coating layers between the substrate and the electrodeposited coating.

Moreover, the topcoat layers may be applied directly onto the electrodepositable coating layer. In other words, the substrate may lack a primer layer. For example, a basecoat layer may be applied directly onto at least a portion of the electrodeposited coating layer.

As used herein, the term “residue” means the partial structure of a reactant that remains in the reaction product following chemical reaction of the reactant. For example, a residue of a monomer in a polymer refers to the partial structure of the monomer that remains in the polymer following polymerization.

As used herein, unless otherwise defined, the term “substantially free” means that the component is present, if at all, in an amount of less than 5% by weight, based on the total weight of the slurry composition.

As used herein, unless otherwise defined, the term “essentially free” means that the component is present, if at all, in an amount of less than 1% by weight, based on the total weight of the slurry composition.

As used herein, unless otherwise defined, the term “completely free” means that the component is not present in the slurry composition, i.e., 0.00% by weight, based on the total weight of the slurry composition.

For purposes of this detailed description, it is to be understood that the disclosure may assume alternative variations and step sequences, except where expressly specified to the contrary. Moreover, other than in any operating examples, or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present disclosure. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

As used herein, “including,” “containing” and like terms are understood in the context of this application to be synonymous with “comprising” and are therefore open-ended and do not exclude the presence of additional undescribed or unrecited elements, materials, ingredients or method steps. Nevertheless, they also include the more restrictive terms “consisting of” and “consisting essentially of.” As used herein, “consisting of” is understood in the context of this application to exclude the presence of any unspecified element, ingredient or method step. As used herein, “consisting essentially of” is understood in the context of this application to include the specified elements, materials, ingredients or method steps “and those that do not materially affect the basic and novel characteristic(s)” of what is being described.

As used herein, the terms “on,” “onto,” “applied on,” “applied onto,” “formed on,” “deposited on,” “deposited onto,” mean formed, overlaid, deposited, or provided on but not necessarily in contact with the surface. For example, a composition “deposited onto” a substrate does not preclude the presence of one or more other intervening coating layers of the same or different composition located between the electrodepositable coating composition and the substrate.

In this application, the use of the singular includes the plural and plural encompasses singular, unless specifically stated otherwise. For example, although reference is made herein to “an” ionic salt group-containing film-forming polymer, “an” aliphatically substituted phenol, “a” cationic salt group former, a combination (i.e., a plurality) of these components may be used. In addition, in this application, the use of “or” means “and/or” unless specifically stated otherwise, even though “and/or” may be explicitly used in certain instances.

Whereas specific aspects of the disclosure have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the disclosure which is to be given the full breadth of the claims appended and any and all equivalents thereof.

Illustrating the disclosure are the following examples, which, however, are not to be considered as limiting the disclosure to their details. Unless otherwise indicated, all parts and percentages in the following examples, as well as throughout the specification, are by weight.

### EXAMPLES

### Example 1: Electrodepositable Coating Compositions Comprising Auxiliary Resins Comprising an Aliphatically Substituted Phenol

### Preparation of a Blocked Polyisocyanate Crosslinker:

1.1 g of dibutyl tin dilaurate, 177.4 g of methyl isobutyl ketone, 567 g of diethylene glycol monobutyl ether, 118 g of ethylene glycol monobutyl ether and 176 g of methanol were mixed in a flask set up for total reflux with stirring under nitrogen. The mixture was heated to a temperature of 35° C., and 1340 g polymeric phenylene diisocyanate (LUPRANATE M20 commercially available from BASF) was added dropwise so that the temperature increased due to the reaction exotherm and was maintained under 100° C. After the addition was complete, a temperature of 100° C. was established in the reaction mixture and the reaction mixture held at temperature until no residual isocyanate was detected by IR spectroscopy. 136 g of methyl isobutyl ketone was then added, and the reaction mixture was allowed to stir for 30 minutes at 100° C., and then was removed from the flask and allowed to cool to ambient temperature.

### Preparation of a Jeffamine Adduct:

To a round-bottom flask, 1300 g of DER732 (liquid aliphatic diepoxide resin that is a reaction product of epichlorohydrin and polypropylene glycol having an epoxide equivalent weight of 310-330 g/equivalent, available from Dow Chemical among other sources), 752 g of Epon™ 880 (a diglycidyl ether of bisphenol A having an epoxide equivalent weight of 188, available from Hexion) and 684 g of bisphenol A were charged. The flask was fitted with a stirrer and temperature measuring probe and blanketed with nitrogen. The mixture was heated to 130° C. where 3 g benzyldimethylamine was added. The mixture exothermed after which the mixture is allowed to cool to 150° C. The temperature is held until the epoxide equivalent weight reached 1370. After charging 360 g of bis(2-(2-butoxyethoxy)ethoxy)methane and 94 g methoxypropanol, the temperature is allowed to cool at 100° C. then 63 g diethanolamine and 5 g of N-methylethylamine were added. The mixture is stirred by 30 minutes of mixing. 440 g of Jeffamine D400 (an amine-terminated polyethylene glycol (polyetheramine) commercially available from Huntsman) was added, and the mixture is allowed to exotherm, followed by heating at 100° C. until viscosity stabilizes. The mixture is then poured into a mixture of 3426 g of deionized water and 81 g of acetic acid. The mixture is stirred for 40 minutes at ambient temperature and 1372 g of deionized water was added.

### Preparation of an Additive Resin:

A 3-liter flask was equipped with a motor driven stainless steel stir blade, a water-cooled condenser, a nitrogen inlet, and a heating mantle with a thermometer connected through a temperature feedback control device. Added to 3-liter flask was 705.37 g DER™ 732, 170.14 g Bisphenol-A, and 11.46 g bis(2-(2-butoxyethoxy)ethoxy)methane. The flask was heated to 130° C. Then, a mixture of 1.65 g benzyldimethyl amine (BASF) and 0.92 g bis(2-(2-butoxyethoxy)ethoxy)methane was added into flask and heated to 135° C. The reaction mixture was then held at 135° C. until EEW was 1230. Then 54.99 g bis(2-(2-butoxyethoxy)ethoxy)methane was added into flask and the reaction temperature was lowered to 100° C. At 100° C., 179.78 g Jeffamine D400 and 6.89 g bis(2-(2-butoxyethoxy)ethoxy)methane were added into reaction mixture and held at 90~95° C. for 4 hours until viscosity stabilized. After viscosity was stable, 22.47 g Epon™ 880 and 5.05 g bis(2-(2-butoxyethoxy)ethoxy)methane was added into flask. The reaction mixture was held at 90~95° C. until viscosity was stable.

### Preparation of the Standard Main Film-Forming Resin (“Standard Main Resin”):

A 12-liter flask was equipped with a motor driven stainless steel stir blade, a water-cooled condenser, a nitrogen inlet, and a heating mantle with a thermometer connected through a temperature feedback control device. Added to 3-liter flask was 676.1 g Epon™ 880, 206.8 g bisphenol-A, 46.5 g cyclohexylamine, 56.1 g ethoxylated bisphenol-A polyol, 30.5 g methylisobutylketone and 0.3 g EtPPBr (ethyltriphenylphosphonium bromide) were premixed in a conical flask. The flask was heated to 130° C., letting the reaction to exotherm to 145° C. The reaction mixture was then held at 145° C. for 2 hours. After the hold, 88.4 g of methylisobutylketone, 28.6 g Ethoxylated bisphenol-A polyol, and 84.2 g ARCOL Polyol PPG 725 (available from Covestro LLC), followed by 592.9 g of the blocked polyisocyanate described above were added while cooling to 105° C. At 105° C., 49.0 g diketimine (reaction product of diethylene triamine and methylisobutylketone, 73% solids in methylisobutylketone) was added, followed by 44.7 g of N-methylethanol amine, letting the reaction to exotherm to 120° C. The reaction mixture was then held at 120° C. for 1 hour. After 1 hour hold, 1904 g of this resin mixture was then added to the mixture 27 g 90% formic acid, 110 g of deionized water, and 213 g of the Jeffamine Adduct described above and mixed for 30 minutes. 1455 g Deionized water was added into reaction mixture and mixed for 30 minutes. Additional 1100 g of deionized water was added and the solvent removed by vacuum distillation.

### Preparation of Comparative Auxiliary Resin A:

A 3-liter flask was equipped with a motor driven stainless steel stir blade, a water-cooled condenser, a nitrogen inlet, and a heating mantle with a thermometer connected through a temperature feedback control device. Added to 3-liter flask was 511.5 g of Epon™ 880, 214.8 g bisphenol-A, 0.2 g Tetronic 150R1 (a tetrafunctional block copolymer with terminal secondary hydroxyl group surfactant commercially available from BASF), 52.7 g bis(2-(2-butoxyethoxy)ethoxy)methane, and 98.0 g ethoxylated bisphenol-A polyol that were premixed in a conical flask. The flask was heated to 60° C., at this temperature 62.1 g aminopropyldiethanolamine, 3.9 g ethanolamine and 40.3 g diethanolamine were added to the flask, letting the reaction to exotherm to 180° C. The reaction mixture was then held at 170° C. for 1 hour. After the hold, 6.8 g of methylisobutylketone and 20.5 g Dowanol™ PM were added while cooling to 145° C. At 145° C., 17.7 g Epon™ 880 was added. After 1 hour hold, 600.2 g of the blocked polyisocyanate crosslinker was added to the reaction mixture while cooling to 110° C. 21.3 g acetic acid was added and mixed for 15 minutes. After 60 minutes, 836.0 g of deionized water was added and stirred for an additional 30 minutes.

### Preparation of Experimental Auxiliary Resin 1:

A 3-liter flask was equipped with a motor driven stainless steel stir blade, a water-cooled condenser, a nitrogen inlet, and a heating mantle with a thermometer connected through a temperature feedback control device. Added to 3-liter flask was 273.5 g Epon™ 880, 57.4 g bisphenol-A, 154.1 g Cardolite®NX-4005 (an aliphatically substituted phenol that is a cardanol-derivative according to structure (IV) having a hydroxyl equivalent weight of 316 g/equivalent), 0.1 g Tetronic 150R1, 26.5 g bis(2-(2-butoxyethoxy)ethoxy)methane and 52.4 g ethoxylated bisphenol-A polyol that were premixed in a conical flask. The flask was heated to 60° C., at this temperature 33.2 g aminopropyldiethanolamine, 2.1 g ethanolamine and 21.5 g diethanolamine were added to the flask, letting the reaction to exotherm to 180° C. The reaction mixture was then held at 170° C. for 1 hour. After the hold, 3.7 g of methylisobutylketone and 10.9 g Dowanol™ PM (propylene glycol methyl ether commercially available from The Dow Chemical Company) were added while cooling to 145° C. At 145° C., 8.9 g Epon™ 880 was added. After 1 hour hold, 279.6 g of the blocked polyisocyanate crosslinker was added to the reaction mixture while cooling to 110° C. 11.4 g acetic acid was added and mixed for 15 minutes. 804.3 g of this resin mixture was then added to 1196 g of deionized water.

### Preparation of Experimental Auxiliary Resin 2:

A 3-liter flask was equipped with a motor driven stainless steel stir blade, a water-cooled condenser, a nitrogen inlet, and a heating mantle with a thermometer connected through a temperature feedback control device. Added to 3-liter flask was 210.3 g Epon™ 880, 236.3 g Cardolite®NX-4005, 0.1 g Tetronic 150R1, 26.1 g bis(2-(2-butoxyethoxy)ethoxy)methane and 40.3 g ethoxylated bisphenol-A polyol that were premixed in a conical flask. The flask was heated to 60° C., at this temperature 25.6 g aminopropyldiethanolamine, 1.6 g ethanolamine and 16.6 g diethanolamine were added to the flask, letting the reaction to exotherm to 180° C. The reaction mixture was then held at 170° C. for 1 hour. After the hold, 2.8 g of methylisobutylketone and 8.4 g Dowanol™ PM were added while cooling to 145° C. At 145° C., 8.7 g Epon™ 880 was added. After 1 hour hold, 353.5 g of the blocked polyisocyanate crosslinker was added to the reaction mixture while cooling to 110° C. 8.8 g Acetic acid was added and mixed for 15 minutes. 807.5 g of this resin mixture was then added to 1,192 g of deionized water.

### Preparation of Experimental Auxiliary Resin 3:

A 3-liter flask was equipped with a motor driven stainless steel stir blade, a water-cooled condenser, a nitrogen inlet, and a heating mantle with a thermometer connected through a temperature feedback control device. Added to 3-liter flask was 291.0 g Epon™ 880, 61.1 Bisphenol-A, 105.8 g Cardolite®NX-5266 (an aliphatically substituted phenol that is a cardanol-derivative according to structure (III)), 0.09 g Tetronic 150R1, 28.2 g bis(2-(2-butoxyethoxy)ethoxy)methane and 55.7 g ethoxylated bisphenol-A polyol that were premixed in a conical flask. The flask was heated to 60° C., at this temperature 35.4 g aminopropyldiethanolamine, 2.2 g ethanolamine and 22.9 g diethanolamine were added to the flask and let the reaction to exotherm to 180° C. The reaction mixture was then held at 170° C. for 1 hour. After the hold, 3.9 g of methylisobutylketone and 232.8 g Dowanol™ PM were added while cooling to 145° C. At 145° C., 9.4 g Epon™ 880 was added. After 1 hour hold, 297.4 g of the blocked polyisocyanate crosslinker was added to the reaction mixture while cooling to 110° C. 12.1 g Acetic acid was added and mixed for 15 minutes. 995.8 g of this resin mixture was then added to 1,000 g of deionized water and stirred for an additional 30 minutes.

### Preparation of Experimental Auxiliary Resin 4:

A 3-liter flask was equipped with a motor driven stainless steel stir blade, a water-cooled condenser, a nitrogen inlet, and a heating mantle with a thermometer connected through a temperature feedback control device. Added to 3-liter flask was 291.0 g Epon™ 880, 61.1 g Bisphenol-A, 105.8 g Cardolite®NX-5266, 0.09 g Tetronic 150R1, 28.2 g bis(2-(2-butoxyethoxy)ethoxy)methane and 55.7 ethoxylated bisphenol-A polyol that were premixed in a conical flask. The flask was heated to 60° C., at this temperature 35.4 g aminopropyldiethanolamine, 2.2 g ethanolamine and 22.9 g diethanolamine were added to the flask, letting the reaction to exotherm to 180° C. The reaction mixture was then held at 170° C. for 1 hour. After the hold, 3.9 g of methylisobutylketone and 232.8 g Butyl Cellosolve (2-butoxyethanol) were added while cooling to 145° C. At 145° C., 9.4 g Epon™ 880 was added. After 1 hour hold, 297.4 g of the blocked polyisocyanate crosslinker described above was added to the reaction mixture while cooling to 110° C. 12.1 g acetic acid was added and mixed for 15 minutes. 995.8 g of this resin mixture was then added to 1,000 g of deionized water and was stirred for an additional 30 minutes.

### Preparation of Electrodepositable Coating Compositions:

In a vessel suitable for electrodeposition, each component in the table below was added under stirring. The relative resin used and final DI water added varied slightly based upon differences in the solids and water content for each of the resins added, but each final composition included the same solids and resin content. The solids content of the final compositions was 25%. The mixture was then ultrafiltered after mixing (20% reconstituted with deionized water) before electrodeposition. Each composition included an equal amount (less than 1% by weight, the % by weight based on the resin solids weight) of a catalyst.

Electrodepositable Coating Compositions

| | | Amount | | | | |
|---|---|---|---|---|---|---|
| | | Comparative | Experimental | Experimental | Experimental | Experimental |
| Charge | | Composition | Composition | Composition | Composition | Composition |
| # | Material | A (grams) | 1 (grams) | 2 (grams) | 3 (grams) | 4 (grams) |
| 1 | Standard Main | 1420 | 1455 | 1437 | 1437 | 1437 |
| | Resin | | | | | |
| 2 | Comparative | 540 | — | — | — | — |
| | Auxiliary | | | | | |
| | Resin A | | | | | |
| | Auxiliary | — | 598 | — | — | — |
| | Resin 1 | | | | | |
| | Auxiliary | — | — | 581 | — | — |
| | Resin 2 | | | | | |
| | Auxiliary | — | — | — | 596 | — |
| | Resin 3 | | | | | |
| | Auxiliary | — | — | — | — | 619 |
| | Resin 4 | | | | | |
| 3 | Additive | 47 | 49 | 48 | 48 | 48 |
| | Resin | | | | | |
| 4 | Butyl carbitol | 33 | 34 | 34 | 34 | 34 |
| | formal¹ | | | | | |
| 5 | DI Water | 122 | 80 | 88 | 73 | 51 |
| 6 | Acrylic | 83 | 85 | 84 | 84 | 84 |
| | Microgel² | | | | | |
| 7 | DOWANOL | 46 | 47 | 47 | 47 | 47 |
| | PPH LOW | | | | | |
| | PHENOL | | | | | |
| | GRADE³ | | | | | |
| 8 | Pigment | 295 | 302 | 299 | 299 | 298.7 |
| | Paste⁴ | | | | | |
| 9 | DI Water | 1400 | 1432 | 1414 | 1414 | 1414 |

¹Bis(2-(2-butoxyethoxy)ethoxy)methane available from BASF Corporation.
²As described in Example 2 of U.S. Pub. No. 2021/0324209 A1 at par. [0185] to [0187], the cited portion of which is incorporated herein by reference.
³Commercially available from Dow Chemical Co.
⁴Pigment paste having a solids content of 60% by weight and a pigment-to-binder ratio of 2.36.

The substrates were immersed into a stirring bath containing the electrodepositable coating composition heated to 90° F. (32.2° C.) and connecting the cathode of direct current rectifier to the substrate and connecting the rectifier's anode to stainless steel tubing used to circulate cooling water for bath temperature control. The voltage was increased from 0 to a set point voltage of 190V over a period of 30 seconds and then held at that voltage for an additional 20-120 seconds to deposit the desired film thickness. This combination of time, temperature, and voltage deposited a coating of ~18 microns once cured. After electrodeposition, the panels were removed from the bath, rinsed vigorously with deionized water, and cured at 165° C. for 20 minutes in a Despatch LFD 1-42 electric oven. This process was performed for electrogalvanized steel substrates (EZG) or cold-rolled steel (CRS) that were either phosphated ((EZG/C700, ACT Test Panels Item #31611 or CRS/C700, ACT Test Panels Item #28630) or pretreated with ZIRCOBOND 1.5 (pretreated panels are referenced as “Zb 1.5” in the tables below), commercially available from PPG Industries. For EZG and CRS panels pretreated with ZIRCOBOND 1.5 pretreatment, the panels were cleaned and pretreated according to the method described in Int'l Pub. No. WO 2018/039462 A1, Example 2 using the “Standard Cleaner”, as described in paragraphs to [0279].

The coating panels were tested for appearance (Ra), throwpower, cure, flexibility (mandrel bend), impact resistance, and corrosion resistance. The test procedures and results are provided below.

### Appearance (Surface Roughness) Test Procedure:

Surface roughness was evaluated in accordance with the following method: The electrodepositable coating composition is electrodeposited onto a metal panel and cured by baking in an electric oven, and then coating texture is evaluated using a profilometer over a specified length of the panel, filtering the roughness profile according to ISO 4287-1997 3.1.6 using an Lc parameter of 2.5 mm and an Ls parameter of 8 μm before summarizing an Ra metric according to ISO 4287-1997 4.2.1, hereinafter referred to as Ra. A specific test procedure is performed as follows: The electrodepositable coating composition was electrodeposited onto a metal panel having a size of 4×6×0.032 inches and the coating was cured by baking in an electric oven for 25 minutes at 175° C. The coating texture was evaluated using a Mitutoyo Surftest SJ-402 skidless stylus profilometer equipped with a 4 mN detector and a diamond stylus tip with a 90° cone and a 5 μm tip radius. The scan length, measuring speed, and data sampling interval was 48 mm, 1 mm/s, and 5 μm, respectively. The raw data is first filtered to a roughness profile according to ISO 4287-1997 3.1.6 using an Lc parameter of 2.5 mm and an Ls parameter of 8 μm before summarizing an Ra metric according to ISO 4287-1997 4.2.1. This test is referred to herein as the SURFACE ROUGHNESS TEST METHOD.

### Throwpower:

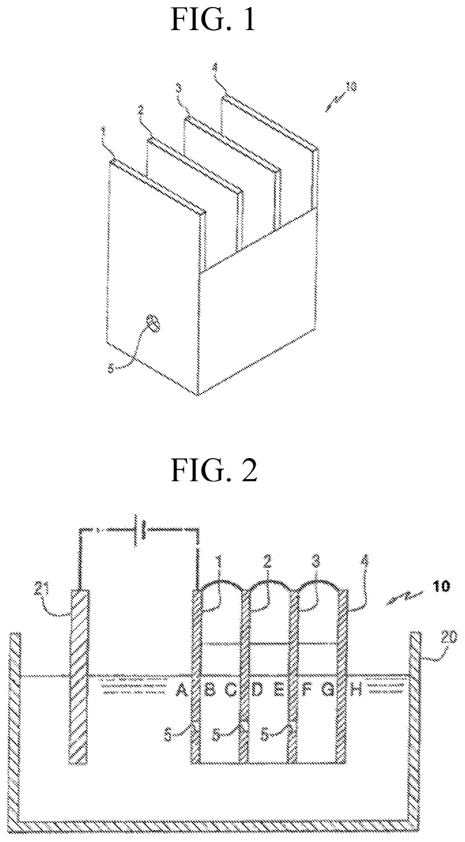

The throwpower was evaluated in accordance with the “Nagoya Box Method” as shown in FIGS. 1 and 2. The Nagoya Box 10 has 4 parallel metal plates 1, 2, 3 and 4 having dimensions of 6.9 cm (w)×15.2 cm (I) with a distance of 20 mm between them with the bottom and sides sealed. Through holes 5 of diameter 1.6 cm are centered 5 cm from the bottom edge of the metal plates 1, 2, and 3, but not 4. The box 10 was immersed into an electrodeposition coating container 20 filled with a cathodic electrodeposition coating material. In this case, the cathodic electrodeposition coating material flows into the box 10 only from each through hole 5. While stirring the cathodic electrodeposition coating material, the metal plates 1 to 4 are electrically connected and a counter electrode 21 was disposed at a distance of 150 mm from the metal plate 1. A voltage is applied to the metal plates 1~4 as a negative electrode and the counter electrode 21 as a positive electrode to conduct a cathodic electrodeposition coating. The box 10 was immersed in an electrodepositable composition (ED 7000Z from PPG Industries) heated to 32° C. that was magnetically stirred. Each panel served as a cathode that was electrically connected to a counter electrode spaced 150 mm from the first panel. Voltage was applied to the panels for a duration in which there was an initial 30 second ramp imposed to rise to 190V. Once at 190V, the voltage was maintained for 180 seconds. Following coat-out, the coated panels were rinsed thoroughly in deionized water and placed in an electric oven heated to 175° C. for 25 minutes. The thickness and uniformity of the coating on each panel face was evaluated in 4 regions positioned at right angles spaced 1 mm away from the center hole on 1, 2 and 3 panels. These locations were also examined on the face of 4 panel which did not contain a hole. In order to assess the throwpower of the electrodepositable composition, the film thickness on G face was divided by the film thickness on A face and multiplied by 100%.

### Mandrel Bend Test Method:

Coatings were evaluated for flexibility (and resulting lifting or cracking of the coating) using the mandrel bend test method performed according to ASTM D 522 (December 2010) with results reported in mm.

### Reverse Impact Test Method:

The coatings were evaluated for impact resistance using the reverse impact test method performed according to ASTM D 2794-93 (2019) with results reported in inch-pounds.

Corrosion resistance was evaluated by both the Hot Water Salt Dip and GMW14782 test methods described below.

### Hot Water Salt Dip (HSD) Corrosion Testing:

Panels were tested for scribe creep blistering using Hot Salt Dip. Scribe creep was measured from affected paint to affected paint to the left and right of the scribe. An X-shaped scribe was placed into the cured coating to the panel prior to being placed into the immersion cabinet for a length of 10 days. The immersion solution was a 5 percent NaCl salt solution at a temperature of 55° C.

### GMW14782 Corrosion Testing:

Coated panels were subjected to a GM cyclic corrosion test GMW 14872 (November 2022) in which the panels were scratched by cutting through the coating system down to metal substrate (10.2 cm vertical line in the middle). The panels were exposed to condensing humidity (8 hours at 25° C. and 45 percent humidity then 8 hours at 49° C. and 100 percent humidity followed by 8 hours at 60° C. and 30 percent humidity) for 40 days. At the end of the test, the panels were rated by measuring the paint loss from the scribe (creep) and the maximum creepage (both sides) calculated in millimeters for each panel.

| | | | | | Throwpower |
|---|---|---|---|---|---|
| | | | | | (190 V, 90° F.) |
| | Appearance Data (DFT 18 um, | | | | 3 min |
| | Bake 175° C./20 min) | | | | deposition) |
| | | | Ra CRS | Ra EZG | % Throwpower |
| Description | Ra CRS | Ra EZG | Zb 1.5 | Zb 1.5 | (G/A) |
| Comparative | 0.117 | 0.195 | 0.0963 | 0.189 | 52% |
| Comp. A | | | | | |
| Ex. Comp. 1 | 0.112 | 0.236 | 0.192 | 0.231 | 46% |
| Ex. Comp. 2 | 0.144 | 0.346 | 0.216 | 0.261 | 39% |
| Ex. Comp. 3 | 0.239 | 0.203 | 0.332 | 0.245 | 45% |
| Ex. Comp. 4^{a} | 0.174 | 0.140 | 0.259 | 0.226 | N/A |

^{a}Experimental composition 4 was only tested for appearance because of its similarity to Experimental Composition 3 with the exception of solvent used.

| | mandrel bend | | | | |
|---|---|---|---|---|---|
| | (mm) | | Reverse Impact | Corrosion | |
| | 155 | 175 | (inch pounds) | HSD | GMW14872 |
| Description | 25 min | 25 min | 155 25 min | scribe mm | scribe mm |
| Comparative | 8 | 13 | 20 | 0.62 | 3.5 |
| Experimental | 4 | 11 | 60 | 0.21 | 2.2 |
| Composition 1 | | | | | |
| Experimental | 6 | 11 | 20 | 0.46 | 1.8 |
| Composition 2 | | | | | |
| Experimental | 0 | 12 | 40 | 0.29 | 3.9 |
| Composition 3 | | | | | |
| Experimental | N/A | N/A | N/A | N/A | N/A |
| Composition 4 | | | | | |

These results demonstrate the experimental electrodepositable coating compositions provide satisfactory performance across all measured properties.

### Example 2: Electrodepositable Coating Compositions Comprising Main Film-Forming Resins Comprising an Aliphatically Substituted Phenol and Optionally Auxiliary Resins Comprising an Aliphatically Substituted Phenol

Preparation of Experimental Main Resin 1: A main film-forming electrocoat resin having 50% of the BPA of the Standard Main Resin from Example 1 replaced by the aliphatically substituted phenol diallyl bisphenol A by the following procedure: A 12-liter flask was equipped with a motor driven stainless steel stir blade, a water-cooled condenser, a nitrogen inlet, and a heating mantle with a thermometer connected through a temperature feedback control device. Added to 3-liter flask was 676.1 g Epon™ 880, 103.4 g bisphenol-A, 139.7 g diallyl bisphenol-A (BX-o-DABPA: commercially available from Bimax), 46.5 g cyclohexylamine, 56.1 g ethoxylated bisphenol-A polyol, 31.6 g methylisobutylketone and 0.28 g EtPPBr (ethyltriphenylphosphonium bromide) that were premixed in a conical flask. The flask was heated to 130° C., and the reaction was allowed to exotherm to 145° C. The reaction mixture was then held at 145° C. for 2 hours. After the hold, 92.1 g of methylisobutylketone, 28.6 g ethoxylated bisphenol-A polyol, and 84.2 g ARCOL Polyol PPG 725 (available from Covestro LLC), followed by 613 g blocked polyisocyanate were added while cooling to 105° C. At 105° C., 49.0 g diketimine (reaction product of diethylene triamine and methylisobutylketone, 73% solids in methylisobutylketone) was added, followed by 44.7 g of N-methylethanol amine, letting the reaction to exotherm to 120° C. The reaction mixture was then held at 120° C. for 1 hour. After 1 hour hold, 1670.4 g of this resin mixture was then added to the mixture 23.1 g 90% formic acid 972.8 g of deionized water, and 186.8 g of the Jeffamine Adduct described above and mixed for 30 minutes. 1276.4 g of deionized water was added into the reaction mixture and the mixture was mixed for 30 minutes. Additional 1100.0 g of deionized water was added and removed the solvent by vacuum distillation.

### Preparation of Experimental Main Resin 2:

A main film-forming electrocoat resin having 100% of the BPA of the Standard Main Resin from Example 1 replaced by the aliphatically substituted phenol diallyl bisphenol A by the following procedure: A 12-liter flask was equipped with a motor driven stainless steel stir blade, a water-cooled condenser, a nitrogen inlet, and a heating mantle with a thermometer connected through a temperature feedback control device. Added to 3-liter flask was 676.1 g Epon™ 880, 279.3 g Diallyl Bisphenol-A (BX-o-DABPA: commercially available from Bimax), 46.5 g cyclohexylamine, 56.1 g Ethoxylated bisphenol-A polyol, 32 g methylisobutylketone and 0.28 g EtPPBr (Ethyltriphenylphosphonium bromide) that were premixed in a conical flask. The flask was heated to 130° C., let the reaction to exotherm to 145° C. The reaction mixture was then held at 145° C. for 2 hours. After the hold, 95.8 g of methylisobutylketone, 28.6 g ethoxylated bisphenol-A polyol, and 84.2 g ARCOL Polyol PPG 725 (available from Covestro LLC), followed by 633 g blocked polyisocyanate were added while cooling to 105° C. At 105° C., 49.0 g diketimine (reaction product of diethylene triamine and methylisobutylketone, 73% solids in methylisobutylketone) was added, followed by 44.7 g of N-methylethanol amine, letting the reaction to exotherm to 120° C. The reaction mixture was then held at 120° C. for 1 hour. After 1 hour hold, 1722.4 g of this resin mixture was then added to the mixture 23.1 g 90% formic acid, 1002.6 g of deionized water, and 192.5 g of the Jeffamine Adduct described above and mixed for 30 minutes. 1315.6 g Deionized water was added into reaction mixture and mixed for 30 minutes. Additional 1100.0 g of Deionized water was added and removed the solvent by vacuum distillation.

### Preparation of Experimental Auxiliary Resin 5:

Experimental Auxiliary Resin 5 was prepared by substituting 50% of the bisphenol A from Comparative Auxiliary Resin A with diallyl bisphenol A. Auxiliary Resin 5 was prepared by the following method: A 3-liter flask was equipped with a motor driven stainless steel stir blade, a water-cooled condenser, a nitrogen inlet, and a heating mantle with a thermometer connected through a temperature feedback control device. Added to 3-liter flask was 302.1 g Epon™ 880, 63.4 g Bisphenol-A, 85.7 g of Diallyl Bisphenol-A (BX-o-DABPA: commercially available from Bimax), 0.09 g Tetronic 150R1, 29.2 g bis(2-(2-butoxyethoxy)ethoxy)methane and 57.9 g ethoxylated bisphenol-A polyol that were premixed in a conical flask. The flask was heated to 60° C., at this temperature 36.7 g aminopropyldiethanolamine, 2.3 g ethanolamine and 23.8 g diethanolamine were added to the flask and let the reaction to exotherm to 180° C. The reaction mixture was then held at 170° C. for 1 hour. After the hold, 4.0 g of methylisobutylketone and 12.1 g Dowanol™ PM were added while cooling to 145° C. At 145° C., 9.8 g Epon™ 880 was added. After 1 hour hold, 308.8 g of the blocked polyisocyanate crosslinker was added to the reaction mixture while cooling to 110° C. 12.6 g acetic acid was added and mixed for 15 minutes. 806.2 g of this resin mixture was then added to 1,000 g of deionized water and was stirred for an additional 30 minutes.

### Preparation of Experimental Auxiliary Resin 6:

Experimental Auxiliary Resin 6 was prepared by substituting 100% of the bisphenol A from Comparative Auxiliary Resin A with diallyl bisphenol A. Auxiliary Resin 6 was prepared by the following method: A 3-liter flask was equipped with a motor driven stainless steel stir blade, a water-cooled condenser, a nitrogen inlet, and a heating mantle with a thermometer connected through a temperature feedback control device. Added to 3-liter flask was 272.8 g Epon™ 880, 154.8 g Diallyl Bisphenol-A (BX-o-DABPA: commercially available from Bimax), 0.08 g Tetronic 150R1, 29.3 g bis(2-(2-butoxyethoxy)ethoxy)methane and 52.2 g ethoxylated bisphenol-A polyol that were premixed in a conical flask. The flask was heated to 60° C., at this temperature 33.1 g aminopropyldiethanolamine, 2.08 g ethanolamine and 21.5 g diethanolamine were added to the flask, letting the reaction to exotherm to 180° C. The reaction mixture was then held at 170° C. for 1 hour. After the hold, 3.6 g of methylisobutylketone and 10.9 g Dowanol™ PM were added while cooling to 145° C. At 145° C., 9.8 g Epon™ 880 was added. After a 1-hour hold, 349.0 g blocked polyisocyanate was added to the reaction mixture while cooling to 110° C. 11.3 g Acetic acid was added and mixed for 15 minutes. 808 g of this resin mixture was then added to 1,200 g of deionized water and was stirred for additional 30 minutes.

### Preparation of Electrodepositable Coating Compositions:

In a vessel suitable for electrodeposition, each component in the table below was added under stirring. The solids content was 25%. The mixture was then ultrafiltered after mixing (20% reconstituted with deionized water) before electrodeposition. Each composition included an equal amount (less than 1% by weight, the % by weight based on the resin solids weight) of a catalyst. Comparative Composition A is the same as described above.

Electrodepositable Coating Compositions

| | | Amount | | | | |
|---|---|---|---|---|---|---|
| | | Comparative | | | | |
| | | Composition | Ex. Comp. | Ex. Comp. | Ex. Comp. | Ex. Comp. |
| # | Material | A (grams) | 5 (grams) | 6 (grams) | 7 (grams) | 8 (grams) |
| 1 | Standard | 1420 | 1437 | 1437 | — | — |
| | Main Resin | | | | | |
| | from Ex. 1 | | | | | |
| | Experimental | — | — | — | 1339 | — |
| | Main Resin 1 | | | | | |
| | Experimental | — | — | — | — | 1275 |
| | Main Resin 2 | | | | | |
| 2 | Comparative | 540 | — | — | — | — |
| | Auxiliary | | | | | |
| | Resin A from | | | | | |
| | Ex. 1 | | | | | |
| | Auxiliary | — | 538 | — | 531 | — |
| | Resin 5 | | | | | |
| | Auxiliary | — | — | 526 | — | 520 |
| | Resin 6 | | | | | |
| 3 | Additive | 47 | 48 | 48 | 47 | 47 |
| | Resin from | | | | | |
| | Ex. 1 | | | | | |
| 4 | Butyl carbitol | 33 | 34 | 34 | 33 | 33 |
| | formal¹ | | | | | |
| 5 | DI Water | 122 | 131 | 143 | 211 | 286 |
| 6 | Acrylic | 83 | 84 | 84 | 83 | 83 |
| | Microgel² | | | | | |
| 7 | DOWANOL | 46 | 47 | 47 | 46 | 46 |
| | PPH LOW | | | | | |
| | PHENOL | | | | | |
| | GRADE³ | | | | | |
| 8 | Pigment | 295 | 298 | 299 | 295 | 295 |
| | Paste⁴ | | | | | |
| 9 | DI Water | 1400 | 1414 | 1414 | 1397 | 1397 |

¹Bis(2-(2-butoxyethoxy)ethoxy)methane available from BASF Corporation.
²As described in Example 2 of U.S. Pub. No. 2021/0324209 A1 at par. [0185] to [0187], the cited portion of which is incorporated herein by reference.
³Commercially available from Dow Chemical Co.
⁴Pigment paste having a solids content of 60% by weight and a pigment-to-binder ratio of 2.36.

The substrates were immersed into a stirring bath containing the electrodepositable coating composition heated to 90° F. (32.2° C.) and connecting the cathode of direct current rectifier to the substrate and connecting the rectifier's anode to stainless steel tubing used to circulate cooling water for bath temperature control. The voltage was increased from 0 to a set point voltage of 190V over a period of 30 seconds and then held at that voltage for an additional 20-120 seconds to deposit the desired film thickness. This combination of time, temperature, and voltage deposited a coating of ~18 microns once cured. After electrodeposition, the panels were removed from the bath, rinsed vigorously with deionized water, and cured at 165° C. for 20 minutes in a Despatch LFD 1-42 electric oven. This process was performed for electrogalvanized steel substrates (EZG) and cold-rolled steel substrates (CRS) as described above, either bare or pretreated as described above.

The coating panels were tested for appearance (Ra), throwpower, cure, flexibility (mandrel bend), impact resistance, and corrosion resistance. The test procedures were the same as in Example 1 and results are provided below.

| | | | | | Throwpower |
|---|---|---|---|---|---|
| | | | | | (190 V, 90° F.) |
| | Appearance Data (DFT 18 um, | | | | 3 min |
| | Bake 175/20 min) | | | | deposition) |
| | Ra | Ra | Ra CRS | Ra EZG | % Throwpower |
| Description | CRS | EZG | Zb 1.5 | Zb 1.5 | (G/A) |
| Comparative | 0.117 | 0.195 | 0.0963 | 0.189 | 52% |
| Comp. A | | | | | |
| Ex. Comp. 5 | 0.169 | 0.247 | 0.139 | 0.205 | 48% |
| Ex. Comp. 6 | 0.138 | 0.243 | 0.132 | 0.199 | 47% |
| Ex. Comp. 7 | 0.176 | 0.313 | 0.216 | 0.328 | N/A |
| Ex. Comp. 8 | 0.176 | 0.24 | 0.212 | 0.312 | N/A |

| | Mandrel Bend (mm) | | Reverse Impact | Corrosion | |
|---|---|---|---|---|---|
| | 155 | 175 | (inch pounds) | HSD Scribe | GMW14872 |
| Description | 25 min | 25 min | 155 25 min | (mm) | scribe (mm) |
| Comparative | 8 | 13 | 20 | 0.62 | 3.5 |
| Comp. A | | | | | |
| Ex. Comp. 5 | 2 | 13 | 60 | 0.35 | 4.6 |
| Ex. Comp. 6 | 6 | 16 | 60 | 0.29 | 4.3 |
| Ex. Comp. 7 | 9 | 14 | 30 | 0.77 | 4.6 |
| Ex. Comp. 8 | 3 | 14 | 10 | 0.49 | 3.9 |

These results demonstrate the experimental electrodepositable coating compositions provide satisfactory performance across all measured properties.

It will be appreciated by skilled artisans that numerous modifications and variations are possible in light of the above disclosure without departing from the broad inventive concepts described and exemplified herein. Accordingly, it is therefore to be understood that the foregoing disclosure is merely illustrative of various exemplary aspects of this application and that numerous modifications and variations can be readily made by skilled artisans which are within the spirit and scope of this application and the accompanying claims.

1. An electrodepositable coating composition comprising:
a cationic salt-group-containing, film-forming resin dispersed in an aqueous medium, the cationic salt-group-containing, film-forming resin comprising the reaction product of a reaction mixture comprising:
(a) a polyepoxide;
(b) at least one polyol comprising an aliphatically substituted phenol comprising at least two phenolic hydroxyl groups; and
(c) a cationic salt group former.

2-4. (canceled)

5. The electrodepositable coating composition of claim 1, wherein the reaction mixture further comprises a mono-functional active-hydrogen-containing component, a mono-functional epoxide-containing component, a mono-functional acid-containing component, or a combination thereof.

6. The electrodepositable coating composition of claim 1, wherein the aliphatically substituted phenol comprises a compound having the structure (I): 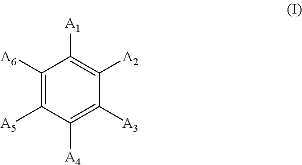
wherein A₁ through A₆ each independently comprise a hydroxyl group, hydrogen, an unsubstituted or substituted, branched or linear, saturated or unsaturated, cyclic, acyclic, or part cyclic aliphatic, aromatic, or aryl-aliphatic group, wherein at least two of A₁ through A₆ are a hydroxyl group, and at least one of A₁ through A₆ is an unsubstituted or substituted, branched or linear, saturated or unsaturated, cyclic, acyclic, or part cyclic aliphatic, aromatic, or aryl-aliphatic group.

7. The electrodepositable coating composition of claim 1, wherein the aliphatically substituted phenol comprises a compound having the structure (II): 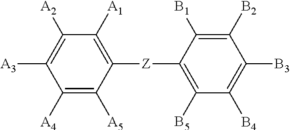
wherein A₁ through A₅ each independently comprise a hydroxyl group, hydrogen, an unsubstituted or substituted, branched or linear, saturated or unsaturated, cyclic, acyclic, or part cyclic aliphatic, aromatic, or aryl-aliphatic group, and at least one of A₁ through A₅ is a hydroxyl group; B₁ through B₅ each independently comprise a hydroxyl group, hydrogen, unsubstituted or substituted, branched or linear, saturated or unsaturated, cyclic, acyclic, or part cyclic aliphatic, aromatic, or aryl-aliphatic, and at least one of B₁ through B₅ is a hydroxyl group; and Z comprises a divalent organic linking group and is not [—C(R)₂—], wherein each R is independently CH₃ or H, if four of A₁ through A₅ and four of B₁ through B₅ are hydrogen.

8. The electrodepositable coating composition of claim 7, wherein at least one of A₁ through A₅ comprises an unsaturated aliphatic group and/or at least one of B₁ through B₅ comprises an unsaturated aliphatic group.

9-12. (canceled)

13. The electrodepositable coating composition of claim 1, wherein the aliphatically substituted phenol comprises a cardanol-derivative.

14. The electrodepositable coating composition of claim 1, wherein the aliphatically substituted phenol comprising the compound having the structure (II) comprises a reaction product of (1) a phenolic lipid comprising an unsaturated aliphatic group and (2) phenol.

15. The electrodepositable coating composition of claim 1, wherein the aliphatically substituted phenol comprises a compound having the structure (III):

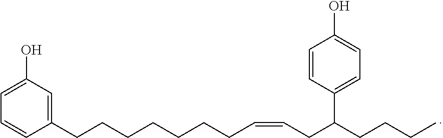 [SMILES: CCCCC(C/C=C\CCCCCCCc1cccc(O)c1)c1ccc(O)cc1]

16. The electrodepositable coating composition of claim 1, wherein the aliphatically substituted phenol comprises a compound having the structure (IV): 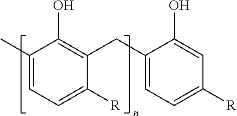
wherein each R independently comprises hydrogen, an unsubstituted or substituted, branched or linear, saturated or unsaturated, cyclic, acyclic, or part cyclic aliphatic, aromatic, or aryl-aliphatic group, and n is 1 to 3.

17. The electrodepositable coating composition of claim 7, wherein the aliphatically substituted phenol comprises diallyl bisphenol A.

18. The electrodepositable coating composition of claim 17, wherein the diallyl bisphenol A has the structure (V):

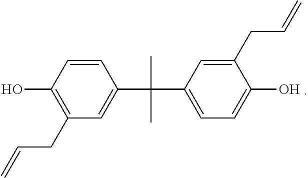 [SMILES: C=CCc1cc(C(C)(C)c2ccc(O)c(CC=C)c2)ccc1O]

19. The electrodepositable coating composition of claim 1, wherein the aliphatically substituted phenol comprises a phenolic lipid.

20-21. (canceled)

22. The electrodepositable coating composition of claim 1, wherein the polyepoxide comprises an aromatic polyepoxide, an aliphatic polyepoxide, or any combination thereof.

23. The electrodepositable coating composition of claim 22, wherein the aromatic polyepoxide comprises a diglycidyl ether of bisphenol A, a diglycidyl ether of bisphenol F, a diglycidyl ether of bisphenol S, a diglycidyl ether of bi-phenol, a diglycidyl ether of a dihydroxy benzene, or any combination thereof.

24. The electrodepositable coating composition of claim 22, wherein the aliphatic polyepoxide comprises hydrogenated diglycidyl ether of bisphenol A, a diglycidyl ether of a diol, or any combination thereof.

25-34. (canceled)

35. The electrodepositable coating composition of claim 1, wherein the reaction product is substantially free, essentially free, or completely free of bisphenol A.

36-37. (canceled)

38. The electrodepositable coating composition of claim 1, wherein the electrodepositable coating composition has a free-bisphenol A content of less than 0.1% by weight, based on the total weight of the electrodepositable coating composition, as measured by HPLC or LC-MS.

39. (canceled)

40. The electrodepositable coating composition of claim 1, further comprising a curing agent.

41-44. (canceled)

45. A method of coating a substrate comprising electrophoretically applying the electrodepositable coating composition of claim 1 to at least a portion of the substrate.

46. A coated substrate comprising a cured coating film comprising the reaction product of:
(a) a cationic salt-group-containing, film-forming resin dispersed in an aqueous medium, the cationic salt-group-containing, film-forming resin comprising the reaction product of a reaction mixture comprising (a) a polyepoxide; (b) at least one polyol comprising an aliphatically substituted phenol comprising at least two phenolic hydroxyl groups; and (c) a cationic salt group former; and
(b) a curing agent.

47-49. (canceled)
